(19) United States
(12) Patent Application Publication
(10) Pub. No.: US 2024/0401958 A1
(43) Pub. Date: Dec. 5, 2024

(54) ROUTE RECONSTRUCTION USING SPARSE DATA SET

(71) Applicant: Apple Inc., Cupertino, CA (US)

(72) Inventors: Saurabh Godha, Santa Clara, CA (US); James T. Curran, Cupertino, CA (US); Fatemeh Ghafoori, Santa Clara, CA (US); Changlin Ma, San Jose, CA (US); Isaac T. Miller, Half Moon Bay, CA (US)

(73) Assignee: Apple Inc., Cupertino, CA (US)

(21) Appl. No.: 18/680,791

(22) Filed: May 31, 2024

Related U.S. Application Data
(60) Provisional application No. 63/470,723, filed on Jun. 2, 2023.
(60) Provisional application No. 63/580,909, filed on Sep. 6, 2023.

(51) Int. Cl. G01C 21/34

(52) U.S. Cl. CPC G01C 21/3415

(57) ABSTRACT

Techniques are described for improving driver efficiency. An example method can include a device accessing sparse location data indicative of one or more geographic locations along a route of the user device during a first time period. The route includes a starting location data point and an ending location data point. The device can access motion data collected by the sensors of the user device. The motion data can be collected by the sensors during the first time period. After a conclusion of the first time period, the device can generate, using the sparse location data and the motion data, a dense data set to reconstruct a route that includes the starting location data point and the ending location data point. The reconstructed route can include second dense location data and velocity data. The device can store the reconstructed route in a local memory of the user device.

### CROSS-REFERENCE TO RELATED APPLICATIONS

This application claims the benefit of U.S. Provisional Application No. 63/470,723, filed on Jun. 2, 2023, and U.S. Provisional Application No. 63/580,909 filed on Sep. 6, 2023, each of which is incorporated by reference in its entirety for all purposes. This application is related to U.S. Application No. 18/______ (Attorney Docket No. 090911-P64449US1-1408347), titled “Low-Power Pedestrian Route Reconstruction,” filed on May 31, 2024. Each of these is incorporated by reference in its entirety for all purposes.

### BACKGROUND

A positioning system can aid in determining a position of an object in three-dimensional space. A computing system can use positioning information to calculate a route from a starting position to a desired position. The computing system can further overlay the route onto a map and display the route and map to provide navigation assistance.

### BRIEF SUMMARY

A system of one or more computers can be configured to perform particular operations or actions by virtue of having software, firmware, hardware, and/or a combination of them installed on the system that, in operation cause the system to perform the actions. One or more computer programs can be configured to perform particular operations or actions by virtue of including instructions that, when executed by data processing apparatus, cause the apparatus to perform the actions.

One general aspect can include a computer-implemented method. The computer implemented method can include a user device accessing sparse location data indicative of one or more geographic locations along a route of the user device during a first time period. The route can include a starting location data point and an ending location data point. The computer implemented method can also include accessing motion data collected by one or more sensors of the user device. The motion data can be collected by the one or more sensors during the first time period. After a conclusion of the first time period, the computer implemented method can also include generating, using the sparse location data and the motion data, a dense data set to reconstruct a route that includes the starting location data point and the ending location data point, the reconstructed route including second dense location data and velocity data. The computer implemented method can also include storing the reconstructed route in a local memory of the user device. Other embodiments of this aspect include corresponding computer systems, apparatus, and computer programs recorded on one or more computer storage devices, each configured to perform the actions of the methods.

Another general aspect can include a computer-implemented method. The computer-implemented method can include accessing a reconstructed route of a vehicle from a starting location data point to an ending location data point. The reconstructed route can be associated with an actual driver and representative of a first set of driving efficiency characteristics. The computer implemented method can also include determining a first energy usage parameter of the reconstructed route by inputting the reconstructed route into an energy consumption model. The computer implemented method can also include generating a simulated version of the reconstructed route by adjusting one or more of the first set of driving efficiency characteristics to define a second set of driving efficiency characteristics. The simulated version of the reconstructed route can be associated with a reference driver of the vehicle. The computer implemented method can also include determining a second energy usage parameter of the simulated version of the reconstructed route by inputting the simulated version of the reconstructed route into the energy consumption model. The computer implemented method can also include providing for presentation at the user device a comparison of the first energy usage parameter and the second energy usage parameter. Other embodiments of this aspect include corresponding computer systems, apparatus, and computer programs recorded on one or more computer storage devices, each configured to perform the actions of the methods.

### BRIEF DESCRIPTION OF THE DRAWINGS

FIG. 1 is an illustration of user device data collection for promoting efficient driving, according to one or more embodiments.

FIG. 2 is an illustration of a route reconstruction process, according to one or more embodiments.

FIG. 3 is an illustration of a reconstructed route and a motion-based route, according to one or more embodiments.

FIG. 4 is an illustration of a system for improving driving efficiency, according to one or more embodiments.

FIG. 5 is a block diagram showing an example architecture or system for improving driver efficiency, according to one or more embodiments.

FIG. 6 is a signaling diagram for generating a reconstructed route, according to one or more embodiments.

FIG. 7 is an illustration of an example road network with an incorrect road segment associations, according to one or more embodiments.

FIG. 8 is an illustration of an example road network for reconstructing a route, according to one or more embodiments.

FIG. 9 is an illustration of a road network on a map application for route reconstruction, according to one or more embodiments.

FIG. 10 is an illustration of a road network on a map application for route reconstruction, according to one or more embodiments.

FIG. 11 is an illustration of a road network on a map application for route reconstruction, according to one or more embodiments.

FIG. 12 is an illustration of a road network on a map application for route reconstruction, according to one or more embodiments.

FIG. 13 is an illustration of example reconstructed route segments determined by a pathfinding algorithm, according to one or more embodiments.

FIG. 14 is an illustration of example reconstructed route segments determined by a pathfinding algorithm, according to one or more embodiments.

FIG. 15 is an illustration of a reconstructed route, according to one or more embodiments.

FIG. 16 is a flowchart illustrating a process 1600 for reconstructing a route, according to one or more embodiments.

FIG. 17 is a process flow for analyzing a route, according to one or more embodiments.

FIG. 18 is an example process for analyzing a reconstructed route, according to one or more embodiments.

FIG. 19 is an example application process, according to one or more embodiments.

FIG. 20 is an example application process, according to one or more embodiments.

FIG. 21 is an example user device, according to one or more embodiments.

FIG. 22 is an example computing system, according to one or more embodiments.

FIG. 23 is an example signaling diagram for communicating with an application programing interface, according to one or more embodiments.

FIG. 24 is an example signaling diagram for communicating with an application programing interface, according to one or more embodiments.

FIG. 25 is an example architecture or environment configured to implement techniques described herein, according to one or more embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Examples of the present disclosure are directed to, among other things, methods, systems, devices, and computer-readable media for improving energy usage on a trip. A vehicle expends energy during each trip, regardless of whether the vehicle is a gas-powered vehicle or an electric vehicle. A vehicle's energy usage efficiency can be a measure of the amount of energy that is converted to cause the vehicle to move compared to the amount of energy that is lost (e.g., converted to heat, sound). The vehicle's energy usage efficiency can be improved by practicing improved driving techniques, such as planning a route to avoid congestion, driving smoothly to reduce rapid acceleration or deceleration, and avoiding idling the engine.

Some vehicles can include computing systems coupled to sensors that can monitor fuel usage to help provide energy usage statistics. However, not all vehicles are equipped with computing systems or applications for performing such tasks. Additionally, in some instances, the information collected by the vehicle's computing system is proprietary and not available to third parties. Therefore, a third-party software application may not have access to vehicle movement data to analyze the vehicle's energy efficiency.

Smartphone technology has evolved such that a user can use their smartphone to collect data similar to the vehicle's computing system. For example, users can use a map application to continuously receive updated location data to navigate to a desired destination. However, using the map applications navigation feature can require the use of sensors and continuous communication with a location service that expends the smartphone's battery life. Furthermore, the continuous communication with the location service can tie up processing capability that the smartphone can use for another purpose.

Embodiments herein describe a methodology for a user device to collect user device data that can be used a proxy for a vehicle's energy usage while on a trip and use that data to generate recommendations for improving the user's driving to decrease the vehicle's energy usage.

In a first particular example, a user device in a vehicle can use its device sensors to collect a sparse set of location data and motion data of the user device while on a route. The user device can use the sparse data set of location data and motion data to infer data points and generate a dense data set. As the user device is located in the vehicle as it is traveling, the dense data set of location data and motion data of the user device can be inferred as a dense set of location data and motion data of the vehicle. The user device can then use the dense set of location data and motion data to reconstruct the route with approximately the same accuracy as if the vehicle and/or user device was continuously using a location service and collecting updated location and motion data.

In a second particular example, a user device can associate sparse location data points to road segments of a road network. The user device can determine a set of road segments that are within a threshold proximity of a first sparse location data point along a route. The user device can also determine a set of road segments that are within the threshold distance of a second sparse location data point along the route. The user device use a pathfinding algorithm to determine a set of road segments traveled along by the user device from the first sparse location data point to the second sparse location data point.

In a third particular example, described herein is a methodology for the user device to use the collected data to generate and provide recommendations to change user driving behavior that may improve the vehicle's energy use efficiency. In the second particular example, the user device can analyze the reconstructed route to determine the vehicle's driving parameters and the vehicle's energy usage. One example of a driving parameter is the average speed of the vehicle. The user device can then generate simulated routes by adjusting one or more of the vehicle's driving parameters. The simulated route can be based on the driving characteristics of a reference driver, whose driving characteristics are an improvement on the actual driver. For example, the user device can adjust the average speed of the vehicle while traveling the same route. The user device can further determine the vehicle's energy usage over the simulated route. The user device can then compare the energy usage of the reconstructed route and the energy usage of the simulated route and determine the difference. The user device can then generate one or more recommendations for the driver to reduce the difference in energy usage and to bring the driver's energy usage in the reconstructed route closer to the energy usage in the simulated route.

Embodiments described herein address the described herein battery consumption issues (e.g., over consumption of battery by a user device sampling location data at a high frequency such as 1 Hz) by providing technical solutions for a user device configured to collect data at various points at a frequency that can be less than the frequency that, for example, a conventional vehicle computing system collects data and/or that user device collects data when running a location collecting device. In a particular situation, the user can drive within the city, which can be characterized by a greater number of traffic lights, a slower average speed and a greater amount of turns than on a highway. At each turn, stop sign, and traffic light, the user may need to decelerate and accelerate as the vehicle passes through. The user device can collect data as the user drives along a route within the city and then later reconstruct the route. The user device can further generate one or more recommendations to improve the user's energy usage efficiency. As these recommendations relate to city driving, the recommendations can include reducing excessive speed between stops, maintaining a steady speed, when possible, and starting to decelerate before a traffic light earlier.

In another particular situation, the user can drive on the highway, which can be characterized by a higher average speed, less congestion, and longer drive times, than when driving in a city. The user device can collect data and reconstruct a route along the highway. The user device can further use the reconstructed route to generate one or more recommendations, As these recommendations are for highway driving, the recommendations can include, for example, driving at a reasonable speed, decreasing the number of lane switches, and reducing instances of rapid deceleration or acceleration.

In another example, rather than continuously traveling from the starting location data point to the ending location data point, a route is divided into two or more segments. In an instance, a user can leave their home in their vehicle, and drive to a parking lot. After the user gets out of their vehicle, the user can enter a friend or co-worker's vehicle as a passenger and be driven in a carpool to work. In other words, a first segment of the route can include the home as the first starting location data point and the parking lot as the first ending location data point. A second segment of the route can include the second starting location data point as the parking lot and the office as the second ending location data point is the office. The user device can reconstruct both segments of the route and determine separate driving parameters for each segment. For example, the user device can determine that the user accelerates and decelerates properly, but does not maintain a steady speed along the first segment. Whereas the user device can determine that the carpool driver drives at a steady speed, but does not accelerate or decelerate properly along the second segment. The user device can further generate recommendations for both segments. The user can receive recommendations for both segments on their user device. The user can further elect to drive at steadier speed based on the recommendation. The user can also provide the carpool driver with a recommendation to accelerate and decelerate more smoothly.

In addition to providing driving improvement recommendation to the driver, the embodiments herein offer an enhanced user experience by performing route reconstruction and recommendation generation with little to no manual input by the user. The user device can begin and end the collection data for route reconstruction based on one or more conditions (e.g., detection of a trigger), rather than receiving a manual input from a user. The user device can additionally begin and perform route reconstruction based on one or more conditions for route reconstruction, rather than receiving a manual input from a user. The different conditions for beginning data collection, route reconstruction, and recommendation generation are discussed below.

It should be appreciated that as described herein the embodiments relate to a vehicle on a road. However, this is for illustration purposes and the herein described embodiments can apply to various forms of travel, such as traveling on a bicycle on a bike path, hiking along a hiking path, or other forms of travel.

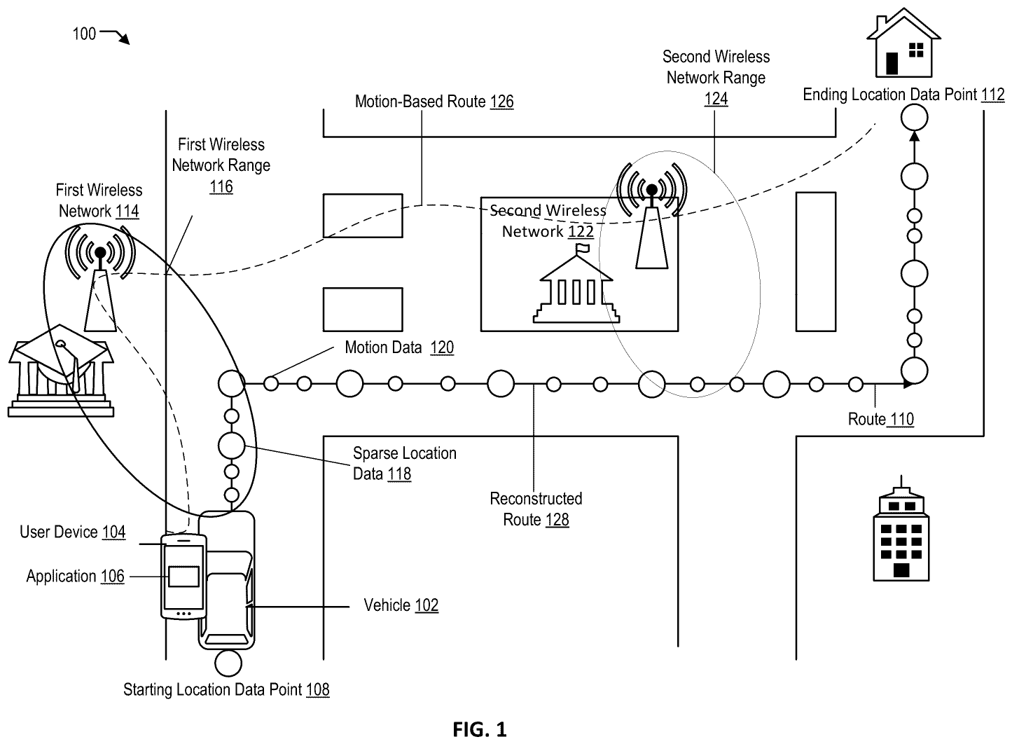

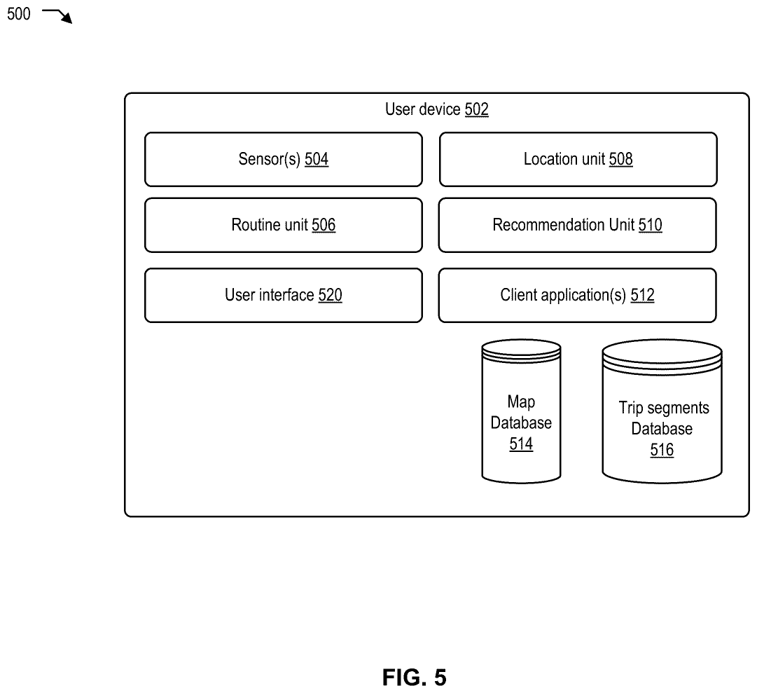

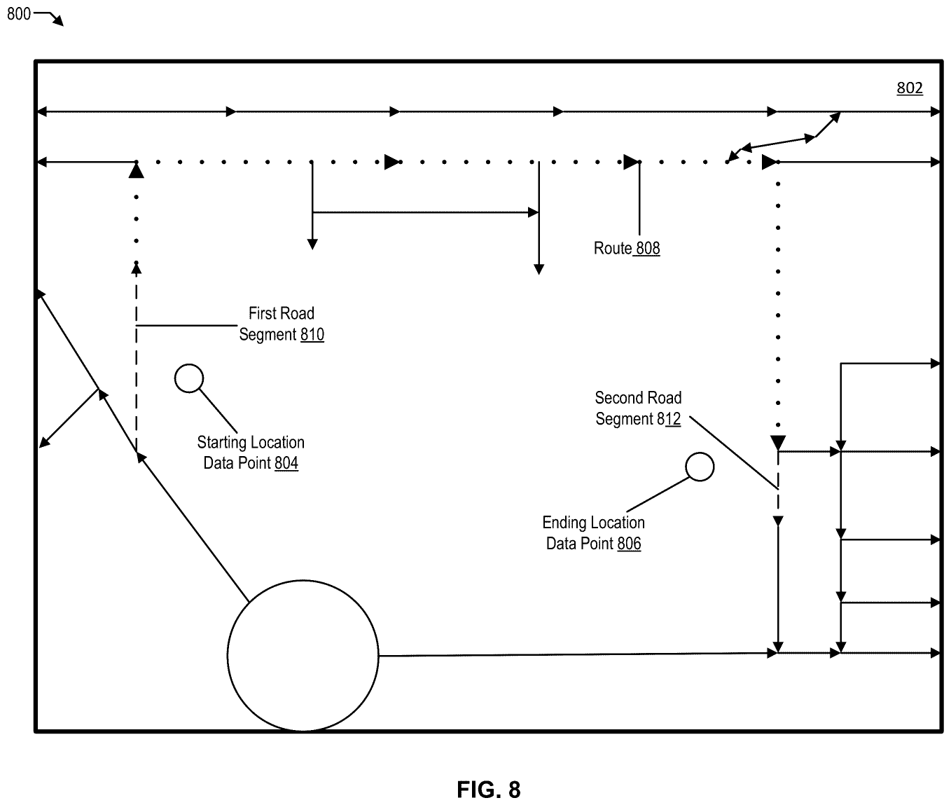

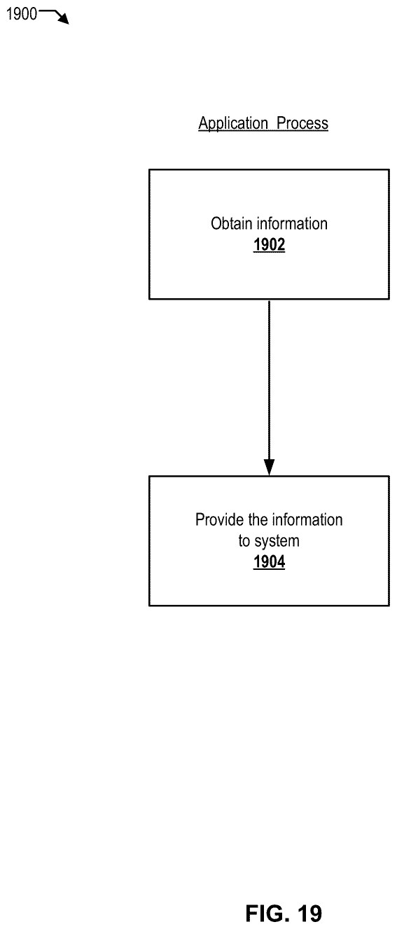

FIG. 1 is an illustration 100 of user device data collection for promoting efficient driving, according to one or more embodiments. FIG. 1 illustrates a vehicle 102 (e.g., an electric vehicle or a gas-powered vehicle) and a user device 104 (e.g., a smartphone, a wearable device, a tablet, a laptop, or other suitable user device) of a user within the vehicle 102. It should be appreciated that although the functionality is described herein with respect to a user device 104, some or all of the functionalities can be controlled by an application 106 (e.g., a map application, a route reconstruction application) executing on the user device 104. In some embodiments, some or all of the functionalities can be controlled by a server device. For time to time, the application 106 may need to make a request (e.g., a request for location data, a request for motion data) from one or more other applications. In these instances, the application 106 can communicate with another application via an application programming interface (API). The application's communication via the API is described with more particularity with respect to FIGS. 19-23. The user device 104 can be powered on and be used for the improvement of energy usage efficiency. As shown in more detail in FIG. 5, the user device 104 can include one or more sensors for collecting motion data and location data. The user device 104 can further include one or more applications that include location services. As indicated above, the embodiments herein rely on data collected by the user device 104, rather than data collected by the vehicle 102. As the user device 104 is located within the vehicle 102 as it travels along the route 110 to the ending location data point 112, the location and motion of the user device 104 at a given time can be representative of the location and motion of the vehicle 102 at a given point. Many vehicles can track location and motion data; however, this data is not readily available for use by third parties. The embodiments herein provide a technical solution of reconstructing a route 110 and determining various route parameters without the assistance of a vehicle's sensors and location and motion tracking capabilities. In particular, the embodiments herein rely on sparse location data collected by the user device 104 and motion data collected from sensors of the user device 104 to reconstruct a route 110 driven by the vehicle. The route 110 may be reconstructed in terms of velocity and acceleration along a road network. The density of the location data for the reconstructed route 128, which is derived from the sparse location data and motion data, may be similar to a hypothetical density that would be present had the location data been collected by a GPS of the user device 104 while the user device 104 moved along the route 110. A process for reconstructing the route 110 from the sparse location data is described with more particularity with respect to FIGS. 8-15.

As illustrated, the vehicle 102 travels from the starting location data point 108 to the ending location data point 112. The user device 104 can determine that the user device 104 is located at the starting location data point 108 of a route 110. For example, the user device 104 can use a computer-implemented service to determine that the vehicle 102 is at the starting location data point 108. In response to determining that the user device 104 is at the starting location data point 108, the user device 104 can determine the location of the starting location data point 108. For example, the user device 104 can communicate with an application executing on the user device 104 and access location data from the application. The location data can include coordinates and a timestamp for when the coordinates were collected. In some instances, the other applications may not have collected location data for an extended period of time. In this situation, there may be no location data that can be accurately assumed to describe a location of the starting location data point 108 Therefore, the user device 104 can compare the timestamp associated with the coordinates with a current time and determine that there is a greater than a threshold interval between the current time and the timestamp. In these instances, the user device 104 can contact a location service or a map application to access the coordinates of the user device 104 at the starting location data point 108.

As indicated above, the user device 104 does not continuously collect location data from the starting location data point 108 to the ending location data point 112 in order to preserve the battery life of the user device 104 and because a user expectation may be that the user device 104 is not gathering dense location data (e.g., the user device 104 is locked and in the user's pocket). Rather than collecting dense location data along the route 110, the user device 104 collects location data of various types and at various time points or time intervals along the route 110 until it determines that the user device 104 is at the ending location data point 112. Various forms of data that can be collected by the user device 104 using the user device's capabilities are illustrated in FIG. 1. For example, the user device 104 can derive information from a detected wireless network (e.g., a Wi-Fi network). As illustrated, as the vehicle 102 travels along the route 110, the user device 104 can detect a first wireless network 114, which can be used by the user device 104 to derive a general location of the user device 104 (and vehicle 102). For example, a college may have a wireless network and broadcast radio signals using one or more Wi-Fi routers. The user device 104 can be equipped with a Wi-Fi receiver for detecting wireless networks. The Wi-Fi signal can include a service set identifier (SSID) that identifies the network (e.g., State College Public Network). It should be appreciated that not all wireless networks broadcast an SSID, and some networks use SSIDs that may not provide any indication of the location of the first wireless network 114. In any event, the user device 104 can log the detection of the first wireless network 114 and a timestamp of the detection.

The user device 104 can then determine a location of the first wireless network 114. Various methods can be used to determine the location of the first wireless network 114. The user device 104 then use access location data (e.g., location data from a map application) and derive a location. For example, if the SSID identifies a state college, the user device 104 can access a map location to determine the location of the state college. In other instances, the user device 104 can contact a location service to access coordinates and timestamps and use this data to determine the location of the wireless network 114.

The user device 104 can also be configured to use other methods, such as estimating the location of the first wireless network 114 based on a signal strength of the broadcasted signal. For example, the user device 104 can use a trilateration method, in which the user device 104 determines the signal strength at different points in time or using different access points. The user device 104 can then calculate an estimated location based on the different signal strengths. In these instances, the user device 104 can be configured to collect the signal strength data while on a route 110 and perform the calculations at a later time. For example, the user device 104 can perform the calculations when connected to Wi-Fi, and in a charging mode. In yet other instances, the user device 104 can use the SSID to determine a location of the first wireless network 114. For example, if the first wireless network 114 State College Public Network, the user device 104 can use access data from a map application and determine the location of State College. The determined location of the first wireless network 114 can fall within a first wireless network range 116. As indicated above, the determined location of the first wireless network 114 is an estimated location that can be based on the accuracy of the location determination techniques.

As indicated above, the user device 104 can be configured to activate one or more sensors to collect data. The user device 104 can further be configured to activate the sensors based on, for example, a pre-determined schedule or one or more triggers. In other words, the user device's activation of the sensors may not be random, in at least some embodiments. The user device's sensor activation schedule can include, for example, a periodic activation (e.g., activate sensors once every x seconds, activate sensors once every 2 minutes), or a mathematical algorithm (e.g., activation schedule based on every other odd or even number). The one or more triggers can include, for example, a first sensor activating based on a second sensor activating, detection of a wireless network, detection of a change in trajectory, or another relevant trigger.

The vehicle 102 can continue to travel along the route 110 and collect a sparse location data 118 at a first point or time interval (e.g., first time interval). The positioning of the sparse location data 118 along the road is for illustration. It should further be appreciated that each time that the user device 104 travels along the route 110, a different sparse set of location data can be collected. For example, as illustrated the location data 118 can include a location from near the starting location data point 108. In another trip, the location data 118 may include a location nearer to or farther from the starting location data point 108. The user device 104 can also collect motion data 120 while on the route 110 using one or more user device sensors. For example, if the user device 104 includes an accelerometer, the accelerometer can collect motion data 120, such as a change in speed and direction of the user device 104. If, for example, the user device 104 includes a gyroscope, the gyroscope can collect motion data 120, such as orientation and rotation of the user device 104. The motion data 120 can be in a time-series format, such that the motion data instance is associated with a respective time stamp. This information can be used reconstruct the path of the user device 104 along the route.

The vehicle 102 can continue to travel along the route 110 and the user device 104 can continue to collect location data 118 and motion data 120. The user device 104 can be configured to continue to collect location data at lower frequency than collection of location data by a location service (e.g., collection by a location service at 1 Hz to 10 Hz). The user device 104 can be configured to collect the location data 118 based on, for example, a pre-determined schedule or one or more triggers. As indicated above, the user device 104 can either communicate with an application that has location service functionality and is operating on the user device 104, or the user device 104 can use the user device's circuitry to communicate with a location service to access location data. The location data 118 can describe a point along the route between the starting location data point 108 and the ending location data point 112. Conventional map applications can continuously collect location data (e.g., collect data at 1 Hz to 10 Hz). However, the continuous collection of location data can drain a user device's batteries. Therefore, the user device 104 can collect location data at slower rate than a conventional map application. The result is that the conventional map application can collect a dense set of location data points, whereas the user device 104 can collect a sparse set of location data points. Using the techniques described-herein, the user device 104 can use the location data 118 and the motion data 120 to infer route data such that the reconstructed route 128 has a dense set of location data points as if the user device 104 collecting location data at 1 Hz or at any other suitable rate.

The vehicle 102 can continue to travel along the route 110 and collect location data 118 and motion data 120, but at a time interval (e.g., a second time interval) along the route 110. For example, the vehicle 102 can continue to travel along the route 110 and detect a second wireless network 122, having a second wireless network range 124. The second wireless network 122 can be a different wireless network than the first wireless network 114 and be located along a different point of the route 110. The vehicle 102 can continue to collect data and until it reaches the ending location data point 112.

It should be appreciated that the number of data points and the order of the collected data points is for illustration purposes only. For example, in a real-world scenario, the user device 104 can detect more than two wireless networks and collect location data and motion data 120 from more than two or three times along a route 110. It should also be appreciated that herein described embodiments include a user device 104 that is configured to collect data at distinct moments along the route 110 rather than a continuous collection of location data 118 and motion data 120 that can drain the battery life.

Once the vehicle 102 has reached the ending location data point 112, the user device 104 can discontinue collecting location data 118 and motion data 120 along the route 110. For example, the user device 104 can determine that the ending location data point 112 has been reached based on receiving an indication from a computer-implemented service. Based on determining that user device 104 has reached an ending location data point 112, the user device 104 can discontinue collecting the data. As indicated above, processing the collected data expends the user device's battery life. Therefore, the user device 104 can be configured to begin processing the collected data based on detecting one or more triggers. The triggers can be indicative of a state of the user device 104, in which the battery life is less likely to be drained. The one or more triggers can also include that the user device 104 is in a charging mode. The one or more triggers can also include that the user device 104 is connected to a local network, such as a Wi-Fi network.

In response to detecting the one or more triggers, the user device 104 can begin the process of generating recommendations for improving driver energy usage efficiency. The user device 104 can perform various steps to generate the recommendations for the user. The user device 104 can retrieve the sparse set of location data and the motion data from the user device's memory and generate inferred data 128 to reconstruct a dense set of data points that describe the route 110 from the starting location data point 108 to the ending location data point 112. In particular, the user device 104 can use dead reckoning technique to generate a motion-based route 126 using the location of the starting location data point 108 and the motion data. The user device 104 can further update the motion-based route using the sparse set of location data 118 along the route including the location of the ending location data point 112 as constraints on the dead-reckoning based route 126. In some embodiments, the updated motion-based route can be used as the reconstructed route 128. In other embodiments, the user device 104 can further access road network data (e.g., map data) and generate the reconstructed route 128 by using the road network data as a constraint on the updated motion-based route. An example method for using the road network to generate a reconstructed route 128 is described with more particularity with respect to FIGS. 8-15.

In some instances, the user device 104 may not have access to road network data, such as in instances that the user device 104 is carried along an unmarked hiking trail or newly built road. In some embodiments, the user device 104 can determine whether road network data exists without manual input from the user. The user device 104 can make the determination based on detecting one or more conditions (e.g., detecting the updated motion-based route). For example, the user device 104 may have stored map tiles in memory, and the user device 104 can compare location data points from each stored map tiles with location data points collected along the route 110. If the user device 104 determines that a threshold value of stored map tile location data points match collected location data points from the sparse location data set, the user device 104 can access the map tile to further update the updated motion-based route. If, however, the user device 104 determines that a threshold value of stored map tile location data points do not match collected location data points from the sparse location data set, the user device 104 can forego accessing the map tile to further update the updated motion-based route.

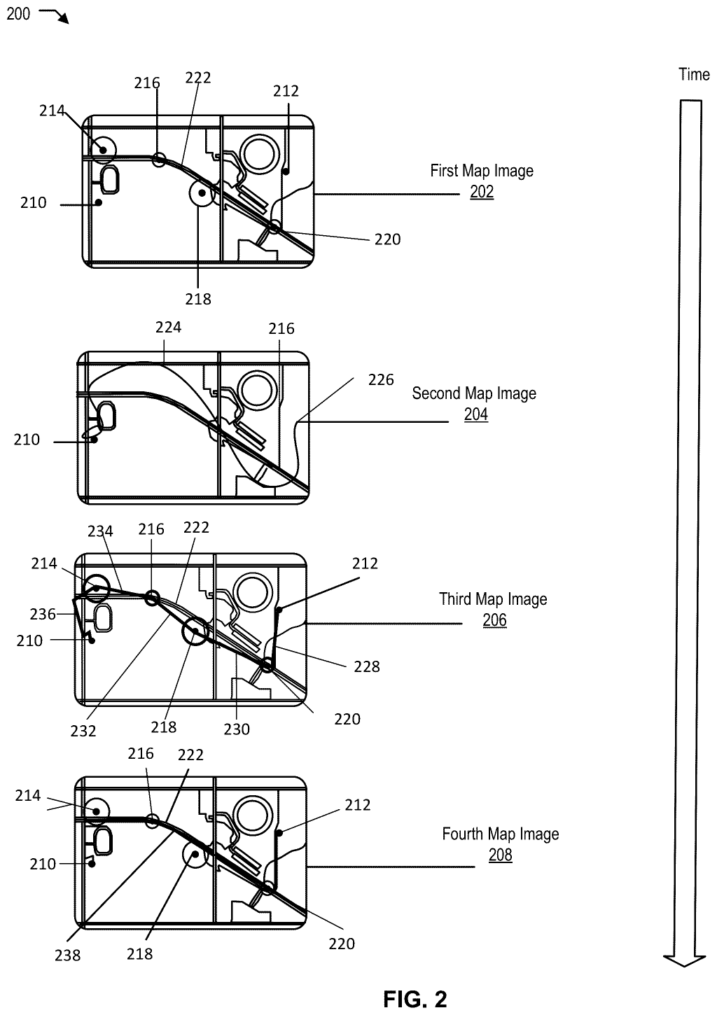

The road network data can identify public and private throughfare (e.g., streets, roads, avenues, alleys, highways) for automobiles. In addition, the road network data can include thoroughfare for non-automobile forms of transportation, such as bike paths, hiking trails, railroad tracks, and walking paths. Therefore, route reconstruction is not necessarily limited to an automobile route reconstruction. Rather embodiments herein can be applied to route reconstruction for various forms of travel, such as bicycling, hiking, and train travel. A route reconstruction process with respect to an automobile. is described with more particularity with respect to FIG. 2.

The road network data can include location data, including location data points that are not collected by the one or more user device sensors. The road network data can further include road segment data and traffic flow data. The inclusion of the road network data can result in the user device including a location data set that has an increased density of location data points in relation to the sparse set of location data. Using this denser set of location data rather than the sparse set of location data points can provide additional data help improve the accuracy of the user device's route reconstruction process.

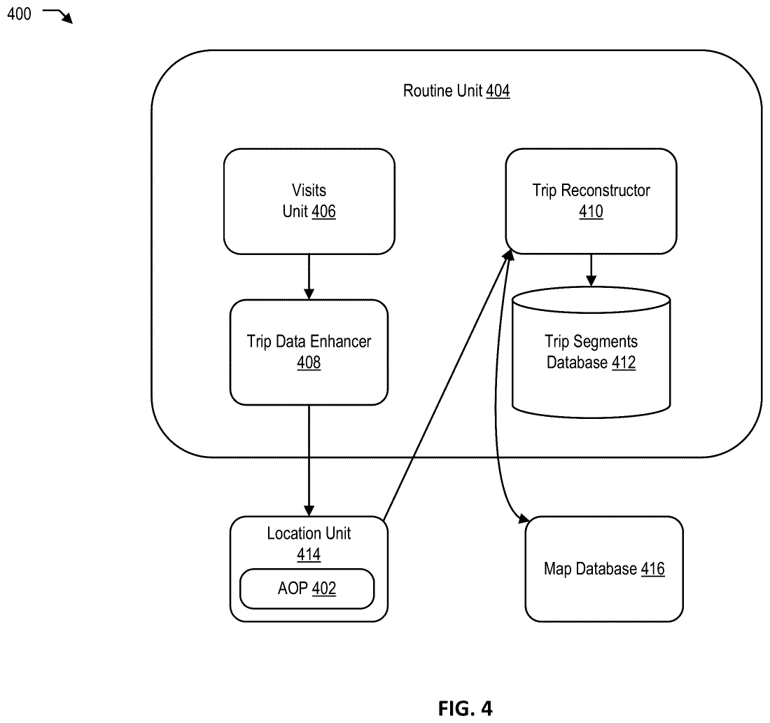

FIG. 2 is an illustration 200 of a route reconstruction process, according to one or more embodiments. FIG. 2 illustrates four processing steps that can be used by the user device (e.g., user device 104) to reconstruct the route (e.g., route 110). Each processing step is illustrated as a map image (first map image 202, second map image 204, third map image 206, and fourth map image 208). One or more of the processing steps can be performed in a different order than as presented in FIG. 2. Furthermore, two or more processing steps can be performed in parallel rather than sequentially as presented. In some examples, the processing steps can be performed by an always-on-processor (AOP) of the user device (e.g., user device 104). The AOP can be a processor that configured to remain powered up when other elements of the user device are powered down. The AOP can be connected to one or more sensors, such as motion sensors for collecting location data and motion data (e.g., motion data 120). An example AOP is described with more particularity with respect to FIG. 4.

The first map image 202 illustrates the first processing step for identifying locations along the route. The user device can retrieve one or more batches of data from memory and identify any location data (e.g., location data 118) included in the batched data. The location data can include locations determined based on, for example, determining the location of a wireless network (e.g., first wireless network 114, second wireless network 122), accessing location data from another application on the user device, or location data accessed by communicating with a location service. The location data can include the location of the starting location data point 210 (e.g., starting location data point 108) and the location of the ending location data point 212 (e.g., ending location data point 112) of the route. The location data can further include locations of intermediate location data points (e.g., first wireless network 114, second wireless network 122) along the route.

As illustrated, the user device has identified a first intermediate location data point 214, a second intermediate location data point 216, a third intermediate location data point 218, and a fourth intermediate location data point 220. It can be seen that the first intermediate location data point 214 and the third intermediate location data point 218 are indicated as being off of the road 222 and the second intermediate location data point 216 and the fourth intermediate location data point 220 are located on the road 222. The reason the intermediate location data points are a combination of points on and off the road 222 can be for a variety of reasons. For example, the first intermediate location data point 214 and the third intermediate location data point 218 can be the locations of Wi-Fi networks near the road 222 (e.g., first wireless network 114 and second wireless network 122). Also, the first intermediate location data point 214 and the third intermediate location data point 218 being indicated to be off the road 222 can be based on a level of accuracy of received location data. It should be appreciated that location services, such as a global positioning system service, include a margin of error that can result from various conditions such as satellite geometry, signal blockage, atmospheric conditions, and hardware design. Therefore, the indicated location may or may not correspond to the exact location on a road that the user device traveled on along the route. Rather the location may fall within a small radius of the exact location that the user device traveled on along the route. In practical terms, the user device would collect more than six location data points, but the number of locations would result in a far sparser data set than a conventional location tracking system. For example, for a conventional location tracking system used on a user device, a sampling rate between 1 Hz and 10 Hz is not uncommon. The embodiments herein describe a user device that can collect location data at various points along a route. At the conclusion of the trip, the user device can have collected a sparse data set of location data. The number of data points in the sparse data can be fewer than, for example, the number of data points collected by a conventional location tracking system (e.g., less than 1 Hz) . . . . However, even with the sparse location data set, the user device can generate a dense data set to reconstruct a route with an accuracy as if the user device had collected the dense set of location data points along the route similar to a conventional location tracking system (e.g., 1 Hz).

The second processing step is illustrated in the second map image 204. In the second processing step, the user device can access the data, including the location data and the motion data, and generate a dead reckoning-based route 224 (e.g., motion-based route 126) from the starting location data point 210 to a projected ending location data point 226. In some embodiments, the user device can use a forward-pass dead reckoning technique to generate the motion-based route 224. Dead reckoning is a generally a navigation method for estimating a vehicle's location based on known initial coordinates (e.g., starting location data point 210) and updating a location based on incremental changes. As described herein, the user device performs dead reckoning to estimate the user device's location to generate the motion-based route 224 from the starting location data point 210 to the projected ending location data point 226. By integrating motion parameters such as speed, orientation, and time derived from the motion and location data collected by the user device sensors, the user device can estimate the user device's location as it moves along the route. The user device then infers the user device's location and motion parameters onto the vehicle.

The user device can rely on motion data (e.g., motion data 120) collected from the one or more sensors to determine the motion parameters along the route accurately. For example, the user device can rely on accelerometer data to determine the user device's acceleration, which enables the estimation of speed and distance traveled along the route. Additionally, the user device can rely on gyroscope data to provide rotation rate measurements for determining changes to the user device's six degrees of freedom orientation. In some embodiments, the user device can further include an inertial measurement unit (IMU) that can use a Kalman filter and integrate the accelerometer data and gyroscope data, to provide a comprehensive solution for user device motion reconstruction.

The user device can execute various algorithms to execute the dead reckoning technique and estimate locations of the user device along the route from the starting location data point to the ending location data point. As an example, the user device can begin with the starting location data point 210. The user device then uses the location data and the motion data to incrementally update the user device's position. The user device then uses the starting location data point 210 and updated positions up to the projected ending location data point 226 to determine the motion-based route 224.

The user device can incrementally update a location of the user device based on a determined positions) of a previous location data point along a route. For example, the user device can use velocity data to determine a displacement (e.g., distance) of the user device from a previous location data point to a subsequent location data point. The starting location data point 210 can be the initial starting location data point for dead reckoning determinations. The user device can determine the location of the starting location data point 210 from the data and use dead reckoning to update the location of the user device from the starting location data point 210 to a next point along the route. In some embodiments, the user device can access acceleration data collected after the user device starts moving. The acceleration data can be collected by a sensor, such as an accelerometer, and be used to determine the user device's velocity at a point in time after the user device moves away from the starting location data point 210.

Referring back to FIG. 1, the user device 104 can begin the route 110 at a first point in time (e.g., T₀) and then at a later point in time (e.g., T₁), the user device 104 can collect location data 118 that can include acceleration information. The user device 104 can access accelerometer data that measures changes in the acceleration of the user device 104. The user device can derive the velocity of the user device 104 at T₁ by integrating the acceleration information over time. The user device 104 can then use the velocity measurement to determine a displacement of the user device 104 from the starting location data point 108 to the location corresponding to the sparse location data 118. The user device 104 can assume that the velocity of the user device 104 remained constant from the starting location data point 108 to the location corresponding to the sparse location data 118. The user device can determine the displacement traveled by the user device 104 over a specific time interval by multiplying the average velocity by the time interval. In this example, the time interval can be the difference in time between the starting location data point (T₀) and the collection of the sparse location data 118 (T₁) (e.g., T₁−T₀=Tᵢₙₜₑᵣᵥₐₗ).

For example, consider a situation in which the user device began to move a T₀. After three seconds have elapsed, the user device 104 begins to collect acceleration data from an accelerometer at a subsequent time (e.g., T₁). The user device can perform an integration operation using the acceleration data to determine the velocity of the user device at T₁. The determined velocity can be considered the average velocity (e.g., x/s) from T₀ to T₁. Therefore, in this example, the user device 104 can determine that the user device 104 traveled 3x distance from T₀ to T₁ (e.g., ((x/s)*3s)=3x).

The user device 104 can further use the collected sensor data to determine an orientation of the user device. For example, the user device 104 can include a gyroscope configured to collect rotational velocity data. The user device 104 can receive the rotational velocity data from the gyroscope and batch together the rotational velocity data along with other collected data to transmit the data to the user device 104. The user device 104 can perform an integration operation on the rotational velocity data to determine the orientation of the user device 104. The orientation of the user device 104 can describe whether the user device 104 is rotating (e.g., turning down a road). As illustrated, the user device 104 has traveled along a straight path from the starting location data point 108 to a location corresponding to the sparse location data 118. If the user device 104 determines that the user device 104 is rotating, the user device 104 can infer that the vehicle 102 is also rotating. It can be further seen that the second sparse location data would be associated with gyroscope data that indicates user device 104 rotated to the right. Combined with the accelerometer data, the user device 104 can determine how far a user device has been displaced and if the user device 104 has rotated. The user device 104 can then infer that the vehicle 102 traveled the same distance and the user device displacement and whether the vehicle 102 turned either right or left. The user device 104 can then update a location of the user device 104 to reflect any displacement along the route 110. As illustrated in FIG. 1, the user device 104 would update the location of the vehicle 102 from the starting location data point 108 at T₀ to the location corresponding to sparse location data 118 at T₁.

The user device 104 can then backfill inferred data for location data points between the starting location data point 108 and the location corresponding to the sparse location data 118. Each inferred data can be associated with an estimated location of the user device 104 at an estimated time. It should be appreciated that the inferred data includes inferred location data points and inferred motion data points, and is calculated by the user device 104 based on the collected sparse location data and the collected motion data. Therefore, the combination of the sparse location data 118 and the inferred location data can comprise a dense location data. The inferred data can further be associated with driving parameters, such as acceleration, orientation, and velocity. The generation of the inferred data can result in a dense data set upon which to analyze energy usage efficiency and generate recommendations for improving energy usage efficiency.

Using the above-described process, the user device 104 can iteratively update the location of the vehicle 102 from the starting location data point 108 to a location along the route 110. For example, the user device 104 can repeat the process to update the location of the user device 104 from a location associated with the sparse location data 118 to a location associated with a subsequent location data point. In addition to updating the location of the user device 104, the user device can use the collected data to update the driving parameters associated with the user device 104.

Referring back to FIG. 2, it can be seen from the second map image 204 that the dead reckoning process is susceptible to errors that increase over the route. As indicated above each location of the user device at a point in time is updated based on the previously determined location of the user device. Therefore, if there is an error in a determined position, that error is carried over to the updated positions of the user device. Therefore, the user device performs additional steps to accurately reconstruct the route. The second map image is illustrative of the route generated through dead reckoning can approximate the route traveled by the user device but is not aligned with the actual road. As illustrated, the route generated by the dead reckoning extends along areas to the left and the right of the actual road. These discrepancies can be the result of various reasons, for example, miscalculating a location of the user device at a given point in time or incomplete data.

The third processing step is illustrated in the third map image 206. The user device can use various computing techniques to recalculate the data points that form the route generated through dead reckoning to include the location data described in the first map image 202. For example, the user device can use a backward pass dead reckoning beginning at the ending location data point 212. While using the forward pass dead reckoning technique to generate the motion-based route 224, the user device determines the motion-based route beginning at the starting location data point and continues to update a location of the user device until the projected ending location data point. On the other hand, the user device incorporates the location data beginning at the ending location data point and incrementally updates the motion-based route 224. The user device can align data points along the motion-based route 224 that were generated using the forward-pass dead reckoning to conform to the location of the intermediate location data point generated as described with respect to the first processing step. The user device can begin by aligning a projected ending location data point generated using a forward-pass dead reckoning technique with the location of the ending location data point as determined by the location data. The user device can then iteratively adjust a segment of the motion-based route between each subsequent determined location until the user device reaches the starting location data point.

As an example, the user device can align the location of the projected ending location data point 226 of the motion-based route 224 determined using the forward-pass dead reckoning with the location of the ending location data point 212. The user device can determine a first road segment 228 from the ending location data point 212 to the fourth, where a first end of the first road segment 228 traverses the ending location data point 212 and a second end traverses the fourth intermediate location data point 220. The user device can then determine a second road segment 230 from the fourth intermediate location data point 220 to the third intermediate location data point 218, where a first end of the second road segment 230 traverses the fourth intermediate location data point 220 and a second end traverses the third intermediate location data point 218. The user device can then determine a third route segment 232 from the third intermediate location data point 218 to the second intermediate location data point 216, where a first end of the third route segment 232 traverses the third intermediate location data point 218 and a second end that traverses the second intermediate location data point 216. The user device can then determine a fourth route segment 234 from the second intermediate location data point 216 to the first intermediate location data point 214, where a first end of the fourth route segment 234 traverses the second intermediate location data point 216 and a second end that traverses the first intermediate location data point 214. The user device can then determine a fifth route segment 236 from the first intermediate location data point 214 to the starting location data point 210, where a first end of the fourth route segment 234 traverses the second intermediate location data point 216 and a second end that traverses the first intermediate location data point 214.

In some embodiments, the user device can determine a discrepancy between the motion-based route 224 and each of the intermediate location data points, and determine new candidates route, in which each new motion-based route incrementally reduces the discrepancy over a previous motion-based route. For example, the user device can determine a discrepancy between the motion-based route 224 and the first intermediate location data point 214. The user device can traverse backwards along each point the motion-based route 224 from the first intermediate location data point 214 to the starting location data point 210. The user device can determine a new motion-based route at each point to reduce the discrepancy between the motion-based route and the first intermediate location data point 214. The user device can repeat this process between the second intermediate location data point 216 and the first intermediate location data point 214. The user device can continue to repeat this process between the third intermediate location data point 218 and the second intermediate location data point 216. The user device can then repeat this process between the fourth intermediate location data point 220 and the third intermediate location data point 218. The user device can repeat the process between the ending location data point 212 and the fourth intermediate location data point 220. The updated motion-based route can better reflect the route as overlapping the road 222.

Although the route generated using the backward pass dead reckoning still results in a few discrepancies between the estimated location of the user device at a given point in time and the road 222, it can be seen that the accuracy of the estimated positions of the user device using backwards pass dead reckoning with location data points as constraints have improved over the forward pass dead reckoning that was not subject to the location constraints. In some embodiments, the updated motion-based route generated using the third processing step can be the reconstructed route.

In some other embodiments, the user device can perform a fourth processing step to reconstruct the route. The fourth processing step is illustrated in the fourth map image 208. During the fourth processing step, the user device can adjust the motion-based route 224 based on using the location data as a constraint. The constraint imposed a requirement that the motion-based route 224 traversed the starting location data point 210, the ending location data point 212 and each of the intermediate location data points. The constraint results in the estimated positions of a user device at a given time more closely overlapping one or more roads that one could conceivably use to travel from the starting location data point 210 to the ending location data point 212.

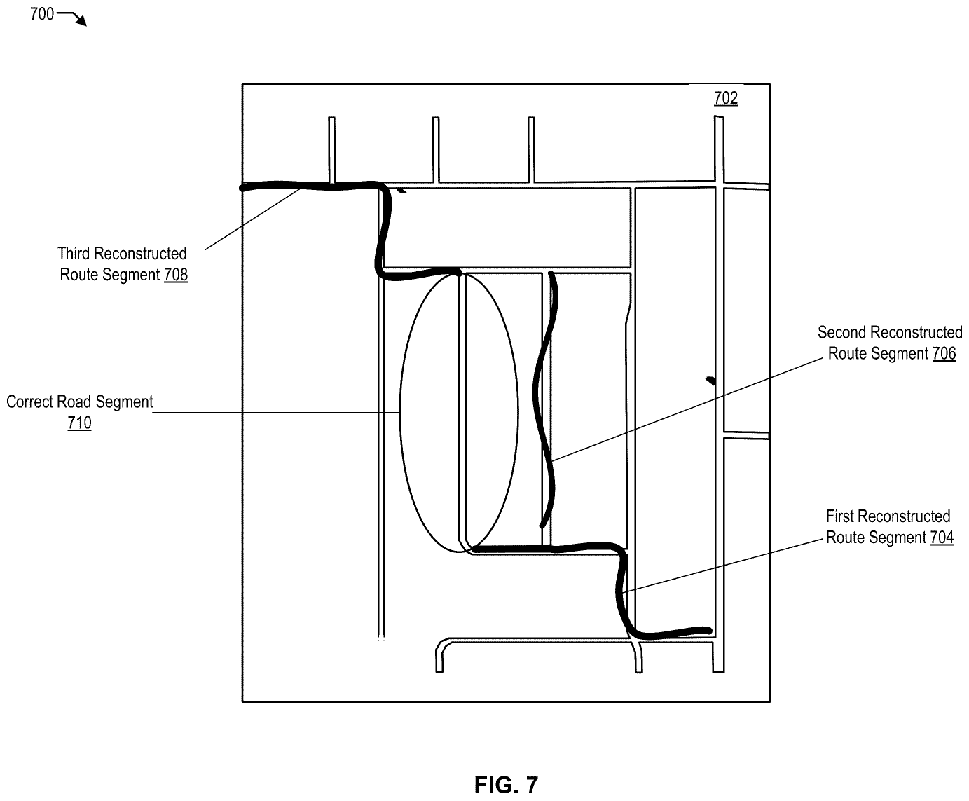

The fourth processing step imposes a further constraint of requiring that the motion-based route 224 traverses a road indicated by data accessed from a map database. This process for determining the road segments is described with more particularity with respect to FIGS. 7-16 The user device can access a map database and use road network data as a constraint for the reconstructed route 238. In some embodiments, the user device can have stored one or more map tiles that describe a road network that includes one or more roads being used to travel from the starting location data point 210 to the ending location data point 212. Map tiles can be used by a location service to render map images for a user and include segmented portions of a map at a particular zoom level. As illustrated, the reconstructed route 238 begins at the starting location data point 210 and ends at the ending location data point 212 overlapping one or more roads, including the road 222. It can further be seen that the reconstructed route 238 continues to traverse, the second intermediate location data point 216 and the fourth intermediate location data point 220, but no longer traverses the first intermediate location data point 214 and the third intermediate location data point 218 based on the constraints.

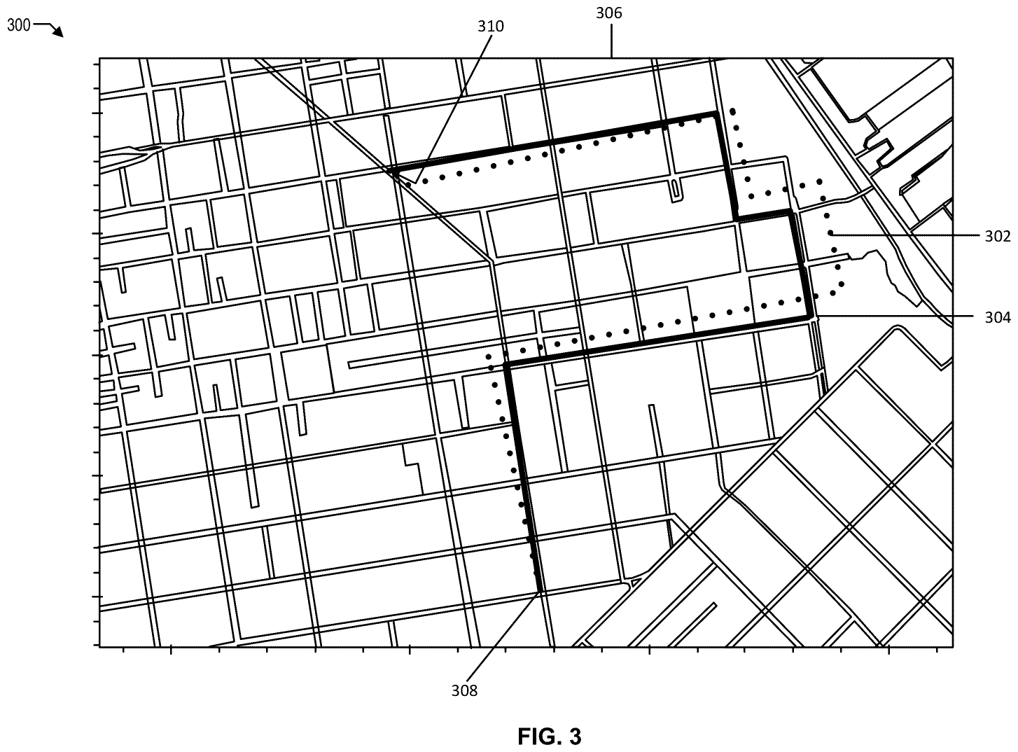

FIG. 3 is an illustration 300 of a reconstructed route and a motion-based route, according to one or more embodiments. A motion-based route 302 (e.g., motion-based route 126) and a reconstructed route 304 (e.g., reconstructed route 128) are overlayed on a map tile 306. A user device can generate the motion-based route 302 using collected data, inferred data, and a forward pass dead reckoning technique as described above motion-based route. It can be seen in FIG. 3 that the motion-based route 302 begins at the starting location data point 308 and continues until a projected ending location data point 310 (e.g., starting location data point 108, starting location data point 210). It can further be seen that the motion-based route 302 generally follows a pattern of the reconstructed route 304 (e.g., reconstructed route 128). However, as illustrated by the overlay on the map tile 306, the motion-based route does not overlap over roads described by the map tile 306. Therefore, to reach the reconstructed route 304, a user device updates the motion-based route based on various constraints. As indicated above, with respect to fourth map image 208 of FIG. 2, the constraint can be that the reconstructed route is overlayed on one or more roads of a road network. FIG. 3 illustrates various shifts to the motion-based route 302 to reach the reconstructed route 304. The ending location data point 310 can be determined by either communicating with another application on the user device that has accessed location data from a location service, or by communicating with a location service as described above.

FIG. 4 is an illustration 400 of a system for improving driving efficiency, according to one or more embodiments. An always-on processor (AOP) 402 of the user device (e.g., user device 104) can control one or more components of the low-level processing system. The low-level processing system can include a routine unit 404 that can include software executable by the user device and includes a visits unit 406, a trip data enhancer 408, a trip reconstructor 410, and a trip segments database 412. As used herein, a trip includes one or more trip segments, that can be grouped together to be meaningful to a user. For example, a user going to a grocery store can travel from their home to a bus stop on a motorcycle. At the bus stop, the user can park their motorcycle and take a bus to the grocery store. This scenario involves two trip segments that can be combined as a single trip to the grocery store. Consider another example, a user drives from home to work and parks at a parking garage connected to the user's office. The user leaves the office and drives back at the end of the day. While at home, the user realizes that he forgot to go to the post office and hails a ride sharing service. The user then hails another driver from the ride sharing service and is driven home. This example also includes four trip segments, and the trip segments from the home to the office and back home can be grouped together. Furthermore, the trip segments from the home to the post office and back home can be grouped together. However, the office trips would not be grouped together with the post office trips as they are unrelated and have no meaningful connection.

The AOP 402 can be operable to execute the code and transmit control instructions to one or more sensors of the user device. The AOP 402 can handle low-level processing for operating on the user device. Low-level processing can include receiving raw unprocessed data from one or more sensors of the user device. This includes receiving, storing and organizing any raw data received from the sensors. Low-level processing can further include data conversion. For example, the raw data from the sensors can be received as an analog signal. The AOP 402 can include a sensor interface that includes an analog-to-digital converter for converting the analog signal from the sensor to a digital signal that is more readily processable by a computing device. The low-level processing can further include signal conditioning and filtering. For example, the AOP 402 can apply one or more filters or digital signal processing techniques to, for example, remove any noise, adjust a frequency, and overall improve the quality of the signals received by the sensors. The AOP 402 can further perform various preprocessing tasks, such as normalization of values, feature extraction, or standardization of values.

The AOP 402 can be connected to one or more user device sensors via a communication interface. Each sensor can be configured to communicate with the AOP 402 via a respective communication protocol. The AOP 402 can be configured to support the respective communication protocol. For example, the low-level processing can further include the AOP 402 configuring the communication interface to communicate with each sensor via the respective communication protocol. The AOP 402 can transmit the control instructions to each sensor over the communication interface and via the respective communication protocol. For example, from time to time, the AOP 402 can transmit control instructions to a sensor to collect data. The control instructions can be for activating the user device's sensors to collect data along the trip. The control instructions can further be for requesting the collected data from the one or more sensors. In response to the control instructions, the sensor can return data, such as measurements related to the location data and the motion data back to the AOP 402 and via the communication interface.

The AOP 402 can execute code to communicate with other applications on the user device to access data gathered by the other applications. For example, some user device applications gather location data of the user device by connecting with a location service. Therefore, the user device can access location data retrieved by another application, rather than connecting with a location service to access the location data. This can have the energy usage benefit of eliminating the energy consumed connecting with the location service and continuously communicating with the service to receive location data.

The visits unit 406 can detect that the user device has departed a starting location data point or arrived at an ending location data point. The visits unit 406 can further be configured to detect departure or arrival without the assistance of a manual input from a user. For example, the visits unit 406 can use an application programming interface (API) to communicate with a service that indicates that the vehicle (e.g., vehicle 102 has departed from a starting location data point (e.g., starting location data point 108). The service can detect whether the user device has departed or arrived using various techniques. For example, in many instances, the user device has previously been paired with a vehicle entertainment system. The user device may further be configured to connect with a paired device (e.g., vehicle entertainment system) when in proximity to the paired device. Therefore, once the user enters the vehicle, the service can detect that the user device has connected with the paired device and that the paired device is associated with a vehicle. Based on detecting the user device has connected with the paired device, either the service or the user device can activate a sensor, such as an accelerometer to determine if the user device begins to move. Based on the connection with the paired device and detecting the movement of the user device, the user device can determine that the user device has departed on a trip. Similarly, the service can detect that the user device has become disconnected from the paired device. Based on detecting that the user device has become disconnected from the paired device, either the user device or the service can activate a user device sensor, such as the accelerometer to determine whether the user device has stopped moving. Based on the disconnection from the paired device and an indication by the sensor that the user device has stopped moving, the user device can determine that the user device has arrived at the ending location data point. In another embodiment, the visits unit 406 can detect that the user device has departed a starting location data point or arrived at an ending location data point based on using a location service. For example, as indicated above, the user device is operable to, from time to time communicate with a location service to access location data. This communication with the location service can be occurring independently of route reconstruction or recommendation generation. The user device can be operable to infer that the user device had departed from a starting location data point based on the location data access from the location service. For example, the user device can access location data indicating that the user device has been confined to a first area for a first threshold period of time. The area may correspond to a building or a house. The user device can further access location data that indicates that the user device has left the area and appears to be moving. The user device can infer that the first area is the starting location data point of a route and the user device has left. Similarly, the user device can further access location data that indicates that the user device has stopped moving. For example, the user device has again been confined to a second area for second threshold period of time. The first threshold of time and the second threshold of time can be the same or different. The user device can infer that the second area is the ending location data point of a route.

The visits unit 406 can activate the trip data enhancer 408, which can use one or more communication protocols to communicate with one or more user device sensors. The user device sensors, can include, for example, a gyroscope, an accelerometer, a magnetometer, an access point, or other appropriate user device sensor. The trip data enhancer 408 can use a respective communication protocol to communicate with various user device sensors. The communication can include transmitting control instructions for activating the sensors to collect data along the trip. As indicated above, the data collection can be at strategic points along a trip, rather than a continuous data collection. The communication can further include control instructions to return any collected data to the trip data enhancer 408. In addition to sensor data, the trip data enhancer 408 can use an API to communicate with one or more applications on the user device to access location data. For example, one or more applications on the user device can, from time to time, use a location service to access the user device location data. In other instances, the trip data enhancer 408 can communicate with a location service to access the user device location data. The trip data enhancer 408 can transmit any collected data to the AOP 402.

The AOP 402 can be included in a location unit 414 configured for estimating a location of the user device at a given time during a trip. The AOP 402 can transmit the collected data received from the trip data enhancer to a trip reconstructor 410.

The trip reconstructor 410 can use the collected sparse data, infer data, and reconstruct the route. For example, as described above, the trip reconstructor 410 can use a forward-pass dead reckoning technique to generate a motion-based route. The trip reconstructor 410 can further update the motion-based route by using a backward-pass dead reckoning technique and using collected location data points as a constraint on the motion-based route. The trip reconstructor 410 further access a map database 416 on the user device. The trip reconstructor 410 can further access a map tile that includes road network data. The trip reconstructor 410 can reconstruct the route by adding an additional constraint of the route overlapping one or more roads included in the map tile. The reconstructed route can estimate a location of the user device along the trip. The determined location of the user device can be inferred onto the vehicle. In addition to the determined location of the user device, the trip reconstructor 410 can determine other driving parameters, such as velocity, acceleration, number of stops, average speed, and other appropriate driving parameters.

The trip reconstructor 410 can further generate simulated routes from the starting location data point and the ending location data point. In particular, the trip reconstructor 410 can adjust one or more driving parameters of the reconstructed route. The trip reconstructor 410 can further use the energy consumption model to determine the energy usage of each of the simulated routes. The trip reconstructor 410 can further determine the difference in energy usage between each simulated route and the reconstructed route. For example, the trip reconstructor 410 can determine that if the vehicle uses another route the vehicle uses 0.5 fewer gallons of gasoline in a simulated route than the reconstructed route.

A trip can include one or more segments. The trip reconstructor 410 can identify each segment in a trip. For example, based on determining that the user device decelerated to a stop and an interval of time passed before the user device accelerated to indicate the user device is in motion. The trip reconstructor 410 can further store each segment in a trip segments database 412 provided by the user device's memory.

In some embodiments, the trip reconstructor 410 can further estimate the certain identifying features of the vehicle (e.g., year, make, and model of the vehicle). For example, based on acceleration time, deceleration time, turning radius, and other appropriate data, the trip reconstructor can determine identifying features of the vehicle. Each vehicle has certain advertised specifications, this specifications can be compared to the information to rule out certain vehicles and identify other vehicles. Through the continued collection of data, the trip reconstructor 410 can continuously narrow down a list of candidate vehicles. This information can be used to determine whether the user device is being carried in the user's dominant form of travel, or perhaps in some other vehicle. In addition, this information can be used to determine for example, whether the user is driving their vehicle or is a passenger in another vehicle. For example, the trip reconstructor 410 can identify the user has been in a particular vehicle (e.g., 2022 Ford Bronco) for a threshold number or threshold percentage of prior trips. The trip reconstructor 410 can determine that the particular vehicle is the user's vehicle. The trip reconstruction 410 can further use current trip information to determine that the user is not in the particular vehicle. Based on determining that the user is not in the particular vehicle, the trip reconstructor 410 can determine that the user is a passenger in someone else's vehicle. This information can further be useful for generating vehicle-specific recommendations for driving improvement. For example, if the trip reconstructor 410 has narrowed down the vehicle to a 2022 Ford Truck, the recommendation can take into consideration the 2022 Ford truck's specifications.

FIG. 5 illustrates a block diagram of an example system 500 for improving driver efficiency, according to one or more embodiments. The system 500 includes a user device 502 (e.g., the user device 104) that includes sensor(s) 504, a routine unit 506 (e.g., routine unit 404), a location unit 508 (e.g., location unit 414), recommendation unit 510, client application(s) 512, a map database 514, and a trip segment database 516. The user device 502 may also include other conventional elements to implement the techniques described herein such as those shown herein.

The user device 502 can include sensors 504 for collecting sparse location data and motion data. For example, the user device 502 can include, for example, an accelerometer, a gyroscope, and magnetometer, and an access point. The routine unit 506 (e.g., the routine unit 404) can include various units to be used to reconstruct a route from the sparse location data and motion data collected over the trip. The location unit 508 can collect data from one or more sources to determine a location of the user device 502 at a given point in time. The client applications 512 may be developed by third-parties, e.g., entities other than the developer of the map database 514, the location unit 508, the routine unit 506 and the recommendation unit 510 and the operating system of the user device 502. In some examples, the developer of the operating system may provide software development kits (SDKs) to enable the developers of the client applications 512 to communicate with the routine unit 506. In some examples, the client applications 512 may include location features for accessing location data of the user device 502. Examples of such client applications 512 include a web-browser, a weather application, a ride sharing application, and a navigation application.

The recommendation unit 510 may provide a model for generating recommendations for improving driver efficiency. The recommendation unit 510 can use an energy consumption model, which is a model that can generate a recommendation for improving driving. In some embodiments, the energy consumption model is implemented as a neural network connected to a reasoning layer, where the reasoning layer is configured to execute an iterative algorithm to generate driving improvement recommendations. The reasoning layer permits the model to employ logical reasoning and inferencing to, for example, determine when to provide a driving efficiency improvement recommendation to a user and what the recommendation is to be.

The reasoning layer can include relevant information on improving driving efficiency. For example, the reasoning layer can receive reconstructed route, simulated routes, the energy efficiency analysis of the trip reconstructor, and other appropriate information as inputs. The other appropriate information can include, for example, identifying features of the vehicle, such as the year, make, and model. The reasoning layer can further include a set of rules to process the information and perform logical operations. The set of rules can include logical reasoning principles like deduction, induction, and abduction, as well as probabilistic reasoning rules. The reasoning layer can integrate a set of rules and the different pieces of relevant information and possibly other data sources.

The reasoning layer performs various logical operations, such as deduction, which involves drawing specific conclusions from general statements or rules. It can also engage in induction, which involves generalizing from specific observations or data to form more general rules or hypotheses. Additionally, the layer may use abduction, which involves generating possible explanations to explain the energy usage. Based on the outcomes of the logical operations, the reasoning layer can make decisions or propose solutions for improving the user's driving efficiency. The reasoning layer can evaluate different options, compare them against specific criteria, and select the most appropriate recommendation to provide the user.

The user device 502 may further include a user interface 520 for displaying the one or more recommendations for improving driver efficiency.

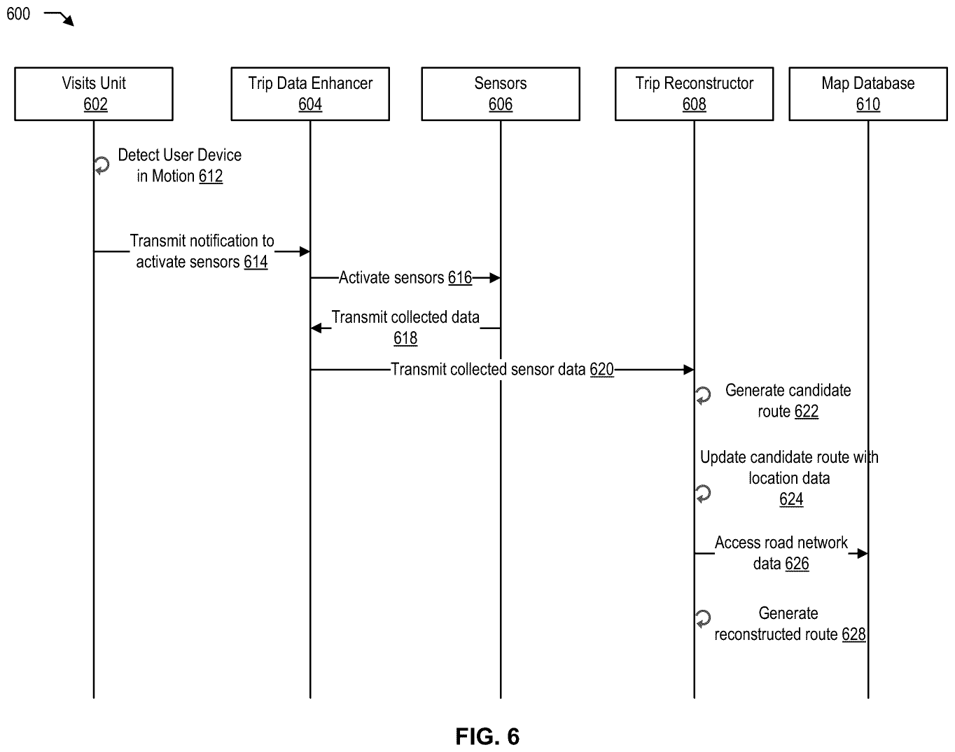

FIG. 6 is a signaling diagram 600 for reconstructing a route, according to one or more embodiments. As illustrated, a visits unit 602 (e.g., visits unit 406) is in communication with a trip data enhancer 604 (e.g., trip data enhancer 408), sensor 606 (e.g., sensors 504), trip reconstructor 608 (e.g., trip reconstructor) and a map database 610 (e.g., map database 416) of a user device (e.g., user device 104). While the operations of processes 1600, 1700, 1800, 1900, 2000, 2200, and 2300, are described as being performed by generic computers, it should be understood that any suitable device may be used to perform one or more operations of these processes. Processes 1600, 1700, 1800, 1900, 2000, 2200, and 2300 (described below) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

At 612, the visits unit 602 can detect that a user device is in motion. For example, the visits unit 602 can receive information to indicate that the user device has begun moving. In this sense, the user device can begin collecting data for route reconstruction without manual input from a user. It should be appreciated that each of the visits unit 602, the trip data enhancer 604, and the trip reconstructor 608 can include code executed by an always on processor (AOP) (e.g., AOP 402) of the user device.

At 614, the visits unit 602 can transmit a notification to the trip data enhancer 604 to activate one or more sensors 606 (e.g., gyroscope, an accelerometer, a magnetometer, an access point, or other appropriate user device sensor) of the user device to collect data (e.g., sparse location data 118 and motion data 120) for reconstructing a route.

At 616, the trip data enhancer 604 can use respective communication protocols to activate one or more sensors 606 of the user device for collecting motion data and/or location data. The trip data enhancer 604 can further transmit instructions to the sensors to collect data. It should be appreciated that for each trip the trip data enhancer 604 may gather different data from the sensors 606. For example, if the user device travels along the same route on two different days, the sensors will gather different data points on each trip.

At 618, the sensors 606 can transmit the collected data to the trip data enhancer 604. The collected data can include sparse location data and motion data collected by one or more of the sensors 606. The sensors 606 can include a gyroscope, an accelerometer, a magnetometer, an access point, or other appropriate user device sensor.

At 620, the trip data enhancer 604 can transmit the collected data to the trip reconstructor 608 with instructions to reconstruct a dense data set describing a route (e.g., route 110) traveled by the vehicle.

At 622, the trip reconstructor 608 can generate a motion-based route (e.g., motion-based route 126). The trip reconstructor 608 can use various techniques to reconstruct the route. For example, the trip reconstructor 608 can use a forward-pass dead reckoning technique to generate a motion-based route. The trip reconstructor 608 can use the sparse location data and the motion data to infer data points. The trip reconstructor 608 can use the collected data points and the inferred data points to generate a motion-based route from a starting location data point (e.g., starting location data point 108) to a projected ending location data point (e.g., ending location data point 112).

At 624, the trip reconstructor 608 can update the motion-based route based on the sparse location data. For example, the trip reconstructor 608 can then use a backward-pass dead reckoning technique to update the motion-based route by having the sparse location data points as constraints. For example, beginning at an ending location data point, the trip reconstructor 608 can update a position of the motion-based route to traverse any detected intermediate location data points (e.g., first wireless network 114, second wireless network 122). In some embodiments, the trip reconstructor 608, can consider the updated motion-based route as the reconstructed route (e.g., reconstructed route 128).

In some other embodiments, at 626, the trip reconstructor 608 can access a map tile from a map database 610. In some instances, the trip reconstructor can access a map tile previously stored on the user device. It should be appreciated that in some instances, there is no map tile that includes the thoroughfare the user device is traveling along. For example, a user can carry a user device to travel along an obscure hiking trail, or along a newly built road. In the event that the trip reconstructor 608 access the map tile, the process can proceed to step 628.

At 628, the trip reconstructor 608 can generate a reconstructed route based on the road network data from the map tile. The trip reconstructor can reconstruct the route by applying the road network as a constraint on the updated motion-based route, such that the reconstructed route overlaps one or more roads of the road network.

As indicated above, the trip reconstructor can use various techniques to reconstruct a route. A technique that relies on dead reckoning is described above. FIGS. 7-16 can collectively describe the technique that snaps location data points to road segments from road network data to reconstruct a route.

As indicated above motion data (e.g., motion data 120) can sometimes lead to inaccurate results. One issue that can occur is that when motion data is associated with a road segment of a road network, the motion data is inaccurate enough such that the motion data is associated with the wrong road segment. FIG. 7 is an illustration of method 700 of an example road network with an incorrect road segment associations, according to one or more embodiments. A road network 702 is illustrated to include a series of interconnected roads, referred to herein as road segments. A user device has attempted to reconstruct a route using location data and motion data as described above. However, as illustrated, rather than a contiguous route, the user device has constructed three distinct route segments (e.g., first reconstructed route segment 704, second reconstructed route segment 706, and third reconstructed route segment 708. The road network 702 indicates that the first constructed route segment 704 and the second reconstructed route segment are correctly aligned on road segments of road network 702. However, the second reconstructed route segment 706 is aligned with the incorrect road segment. For illustration purposes, the correct road segment for 710 has been indicated with an oval. Therefore, the user device can further process the location information and motion information to maintain the first reconstructed route segment 704 and third reconstructed route segment 708, while correcting the second reconstructed route segment to be aligned with the correct road segment of the road network 702. The following figures describe how the user device can formulate a hypothesis of candidate road segments that can be identified to correctly connect two correctly aligned reconstructed route segments (e.g., first reconstructed route segment 704 and second reconstructed route segment 708) via one more intermediate reconstructed route segments. For example, the below techniques can be used to align the second reconstructed route segment 706 on top of the correct road segment 710, such that the first reconstructed route segment 704 is connected to the third reconstructed route segment 708 via the second reconstructed route segment 706.

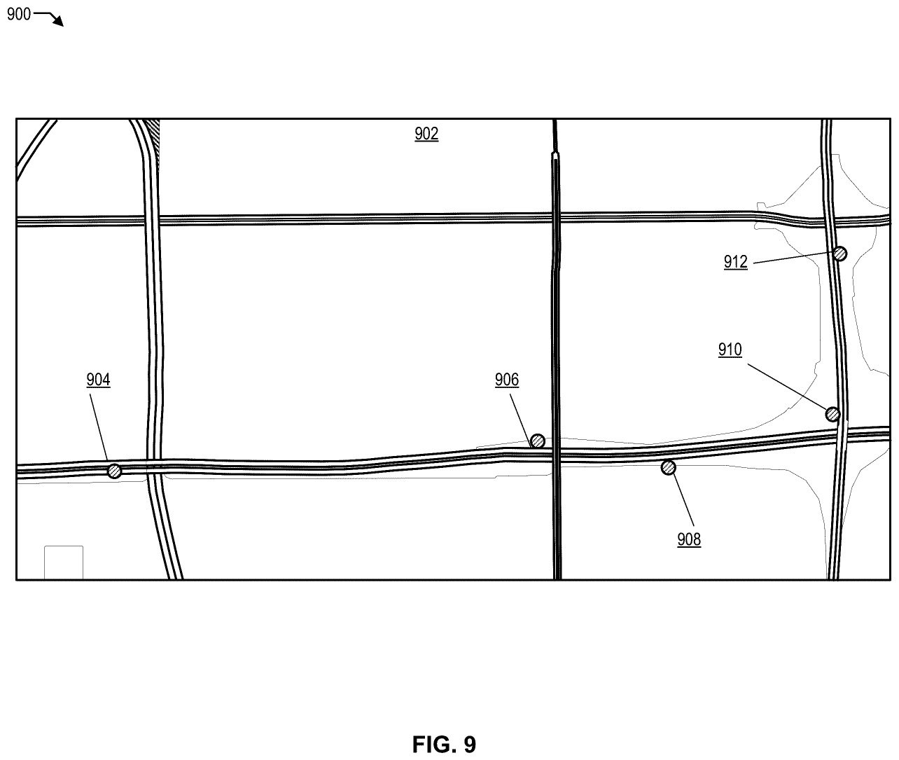

FIG. 8 is a simplified illustration that describes reconstructing a route between two location data points (e.g., the starting location data point 804 and the ending location data point 806) and given the traffic flow direction there is only one path. FIG. 9, on the other hand, illustrates a situation in which a route is to be reconstructed from location data points that could be associated with multiple road segments, multiple paths, and more than two location data points. FIG. 8 is an illustration 800 of an example road network for reconstructing a route, according to one or more embodiments. The road network 802 can include road segments that indicate path and direction of different roads. Each road segment is illustrated as a ray, where a ray may include a line indicating a length of the road segment and a directional arrow indicating a traffic flow direction of the ray. A user device (e.g., user device 104) can access the road network 802 from a map application. For example, the user device can select a map tile from the map application that corresponds to a location data point. The user device can then access the road network from the map application based on the selected map tile. The user device can further use the location data associated with the location data point to determine the location of any location data points to be used to determine a reconstructed route. As illustrated the user device has arranged a starting location data point 804 and an ending location data point 806. The starting location data point 804 can be a location data point collected near the beginning of route 808 (e.g., route 110), and the ending location data point can be location data point collected near the end of the route 808.

It can be further seen that neither the starting location data point 804 nor the ending location data point 806 are located on a road segment of the road network 802. Rather each of these data points is located off to the side of the road network 802. As indicated above, the location data points may not provide completely accurate measurements of the location of the user device. Therefore, it may be necessary for the user device to determine which road segment corresponds to each location data point. The user device can then select the road segment that is closest to the location data point as the corresponding road segment. For example, the user device can consider each road segment as a series of points and each of the starting location data point 804 and the ending location data point 806 also as points. The user device can determine a distance between the starting location data point 804 and each point of each road segment. The user device can then select the road segment that is associated with the shortest distance to the location data point. It should be appreciated that the user can use various other techniques to select the road segment that corresponds to a location data point.

As illustrated, the closest road segment to the starting location data point 804 is the first road segment 810. The closest road segment to the ending location data pint 806 is the second road segment 812. The first road segment 810 and the second road segment have been illustrated as dashed lines to indicate these segments for illustrative purposes. Furthermore, the intermediate section of the route segment 708 is illustrated as dotted lines to indicate the route 808 for illustrative purposes. The user device can “snap” each of the starting location data point 804 and the ending location data point 806 to the first road segment 810 and the second road segment 812, respectively. “Snapping” can include aligning a position of the starting location data point 804 and the ending location data point 806 to a position of the first road segment 810 and the second road segment 812, respectively.

The user device can then determine a set of road segments that connect the first road segment 810 to the second road segment 812. It should be appreciated that FIG. 8 is a simplified illustration, in which each location data point realistically only corresponds to one road segment. Furthermore, given the traffic flow direction, there is only one path from the first road segment to the second road segment 812. In any event, the user device can use a path finding algorithm (e.g., A* search algorithm, Dijkstra's algorithm, Greedy Best-First search, or other appropriate pathfinding algorithm) to determine the route from the first road segment 810 to the second road segment 812. In some embodiments, the user device can use an A* search algorithm. The A* search algorithm can be used to evaluate different nodes on the road network. For example, the road network can be treated as a directed graph, in which each road segment is an array and each point connecting one road segment to another road segment is a node. The A* search algorithm can identify a node at the first road segment 810, the A* search algorithm can then evaluate each neighbor node using the traffic flow direction as a constraint. The A* search algorithm can determine candidate nodes based on whether it would be possible for a vehicle (e.g., vehicle 102) to reach the node while following the correct traffic flow direction. If the vehicle would have to travel against the traffic flow direction to reach the neighbor node, this node would not be a candidate node. As indicated above, the FIG. 8 illustrates a single path for the route 808 to follow. Therefore, for FIG. 8, the A* search algorithm may only determine a single node as a candidate node. Once the A* search algorithm determines a candidate node, the A* search algorithm evaluates the neighbor nodes of each candidate node, and repeats this process until it reaches a node associated with the second road segment 812. If the A* search algorithm had identified multiple motion-based routes, then the A* search algorithm can determine which route is the shortest from the first road segment 810 and the second road segment 812. The A* search algorithm can then select the shortest route as the route used by the vehicle. As there is only one viable path in Figure, the A* search algorithm can determine the indicated route 808.

FIGS. 9-16 describe a more complex scenario, in which location data points may be associated with multiple road segments and there are multiple candidate paths from one location data point to another location data point.

FIG. 9 is an illustration 900 of a road network on a map application for route reconstruction, according to one or more embodiments. As illustrated, a user device (e.g., user device 104) has collected a first sparse location data point 904, a second sparse location data point 906, a third sparse location data point 908, a fourth sparse location data point 910, and a fifth sparse location data point 912. The user device has further accessed a map application executing on the user device. The user device has further accessed a road network 902 from the map application. The user device has further determined the locations of the location data points with respect to the road network 902. For example, the user device can use various location information (e.g., longitudinal and latitudinal coordinates) from the map application and the location data points to determine the location of the location data points with respect to the road network 902. The location data points may form a portion of a route, in which the motion data led to an incorrect alignment with a road segment, such as the incorrect alignment of the second reconstructed route segment 706.

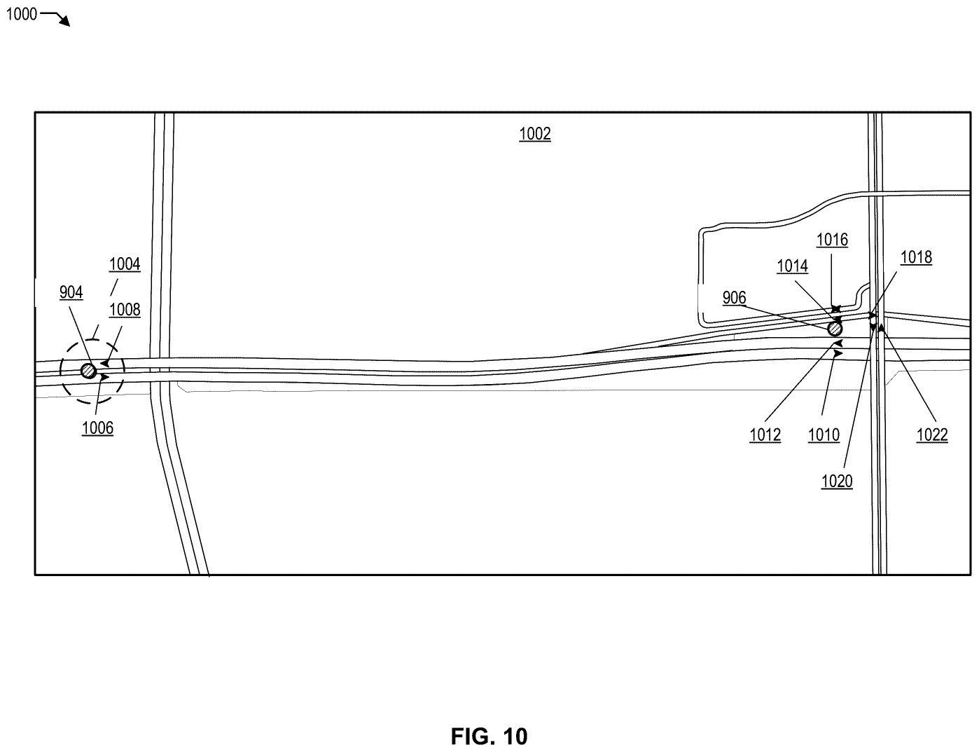

It is further illustrated, that unlike FIG. 8, there are multiple paths from the first sparse location data point 904 to the fifth sparse location data point 912. In addition, there are multiple roads with which a location data point may be associated. Therefore, the user device may perform additional processing steps (e.g., more than described with respect to FIG. 8) in order to determine the route between the first sparse location data point 904 to the fifth sparse location data point 912. FIGS. 10-15 assist in describing the techniques to be used to determine which road segments from a plurality of road segments to select to move from the first sparse location data point 904 to the fifth sparse location data point 912. FIGS. 10-15 also assist with describing techniques for reconstructing a route that includes combining paths between multiple location data points.

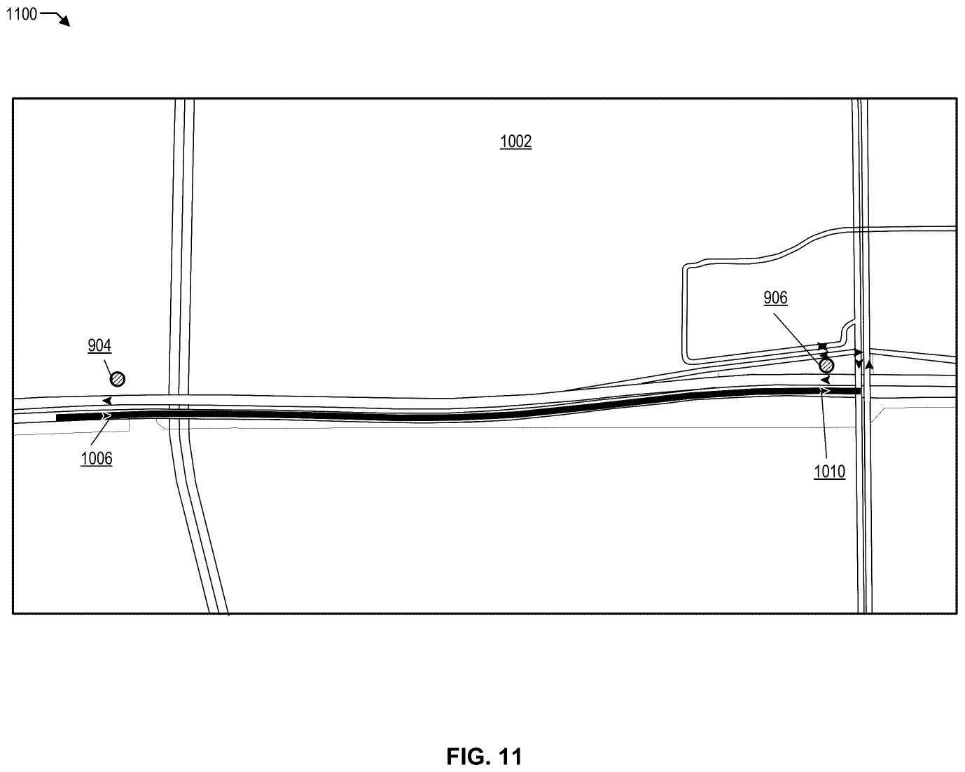

FIGS. 10 and 11 can be viewed together to assist in describing a filtering process for determining a set of road segments traveled along by the user device. FIG. 10 is an illustration 1000 of a road network 1002 on a map application for route reconstruction, according to one or more embodiments. The road network 1002 illustrated in FIG. 10 is blown up and cropped version of the road network 902 of FIG. 9 and includes the first sparse location data point 904 and the second sparse location data point 906. The user device can determine one or more candidate road segments that can correspond to the starting location data point 904. For example, the user device can use an algorithm to evaluate candidate road segments with respect to a proximity parameter (e.g., threshold distance from each location data point, or any other suitable parameter for measurement). For example, the user device can use the threshold distance as a radius and generate a circle 1004 around the location data point using the threshold distance as a radius for the circle. The user device can further determine each road segment that is, at least partially, encompassed by the circle 1004. As illustrated, the user device has determined that first sparse location data point 904 corresponds to a first candidate road segment 1006 and a second candidate road segment 1008. For illustration purposes, the road segments are illustrated as arrows indicating the traffic flow directions of each candidate road segment.

The user device can further determine one or more candidate road segments that correspond to the second sparse location data point 906. The user device can use the same algorithm used to determine the candidate road segments corresponding to the first sparse location data point 904 to determine the candidate road segments corresponding to the second sparse location data point 906. As illustrated, the user device has identified a third candidate road segment 1010, a fourth candidate road segment 1012, a fifth candidate road segment 1014, a sixth candidate road segment 1016, a seventh candidate road segment 1018, an eight candidate road segment 1020, and a ninth candidate road segment 1022. For illustration purposes, arrows indicating the traffic flow directions of each candidate road segment have been illustrated.

The user device can filter through the candidate road segments to determine a set of road segments that connect the first sparse location data point 904 to the second sparse location data point 906. The user device can use a pathfinding algorithm (e.g., (e.g., A* search algorithm, Dijkstra's algorithm, Greedy Best-First search, or other appropriate pathfinding algorithm). The pathfinding algorithm can evaluate each @motion-based route between the sparse location data points 904 and 906 to determine the most likely route from the first sparse location data point 904 to the second sparse location data point 906. The user device can use various constraints to filter out candidate road segments. For example, the user device can use the direction of the user device's movement and the traffic flow direction to filter out candidate road segments. As illustrated, based on the location of the first sparse location data point 904 and the second sparse location data point 906, the direction of the movement of the user device can be determined. The user device can further use the road network 1002 (e.g., data that indicates direction of travel for each road segment) to determine the traffic flow direction associated with the first candidate road segment 1006 and the second candidate road segment 1008. Based on the direction of the traffic flow, the user device can filter out the second candidate road segment 1008 as the traffic flow direction is opposite the user device's movement.

The user device can also use the pathfinding algorithm to filter out candidate road segments. The user device can use the pathfinding algorithm to determine a path from each of the starting candidate road segments (e.g., the first candidate road segment 1006 and the second candidate road segment 1008, if the either had not been filtered out already). For example, the user device can use the pathfinding algorithm to generate a respective path between the first candidate road segment 1006 and each of third candidate road segment 1010 through the ninth candidate road segment 1022. The user device can also use the pathfinding algorithm to generate a respective path between the second candidate road segment 1008 and each of third candidate road segment 1010 through the ninth candidate road segment 1022.

The user device can further constrain the pathfinding algorithm using an estimated time interval between location data points and a reference speed. For example, the user device can detect a time associated with the first sparse location data point 904 (e.g., a timestamp generated when the first sparse location data point 904 was collected. In some embodiments, a constraint can be expressed as:

length=(t2−t1)*reference speed,

where length is distance traveled by the user device, t2 is a time that the first sparse location data point 904 is collected by the user device, t1 is a time that the second sparse location data point 906 is collected, and reference speed can include, for example, a speed limit for the road, an average speed for the road, or other appropriate reference speed. The user device can use the above formulae to determine a length that the user device likely traveled between t1 to t2. Based on the length, the user device can filter out route segments. For example, to move from the first candidate road segment 1006 to the fourth candidate road segment 1012 the user device would need to travel through the third candidate road segment 1010, make a u-turn somewhere, and drive back to reach the fourth candidate road segment 1012. Given the reference speed and the length of the drive from the first candidate road segment 1006, the user device could not move that far of a length within the time interval (t2−t1). Therefore, the user device can filter the fourth candidate road segment 1012. Similarly, the user device would not have enough time between t1 and t2 to reach any of the fifth candidate road segment 1014, the sixth candidate road segment 1016, the seventh candidate road segment 1018, the eighth candidate road segment 1020, or the ninth candidate road segment 1022. In this example, the only viable route moves from the first candidate road segment 1006 to the third candidate road segment 1010.

FIG. 11 is an illustration 1100 of a road network on a map application for route reconstruction, according to one or more embodiments. FIG. 11 can illustrate the same road network 1002 as the road network 1002 of FIG. 10. FIG. 11 highlights that a set of road segments (e.g., the first candidate road segment 1006, the third candidate road segment 1010, and intermediate road segments (if any)) along the same road that connect the first candidate road segment 1006 to the third candidate road segment 1010. Based on selecting the first candidate road segment 1006 and the third candidate road segment 1010, the user device can align the location of the first location data point 904 to the first candidate road segment 1006, and align the location of the second location data point 906 to the third candidate road segment 1010.

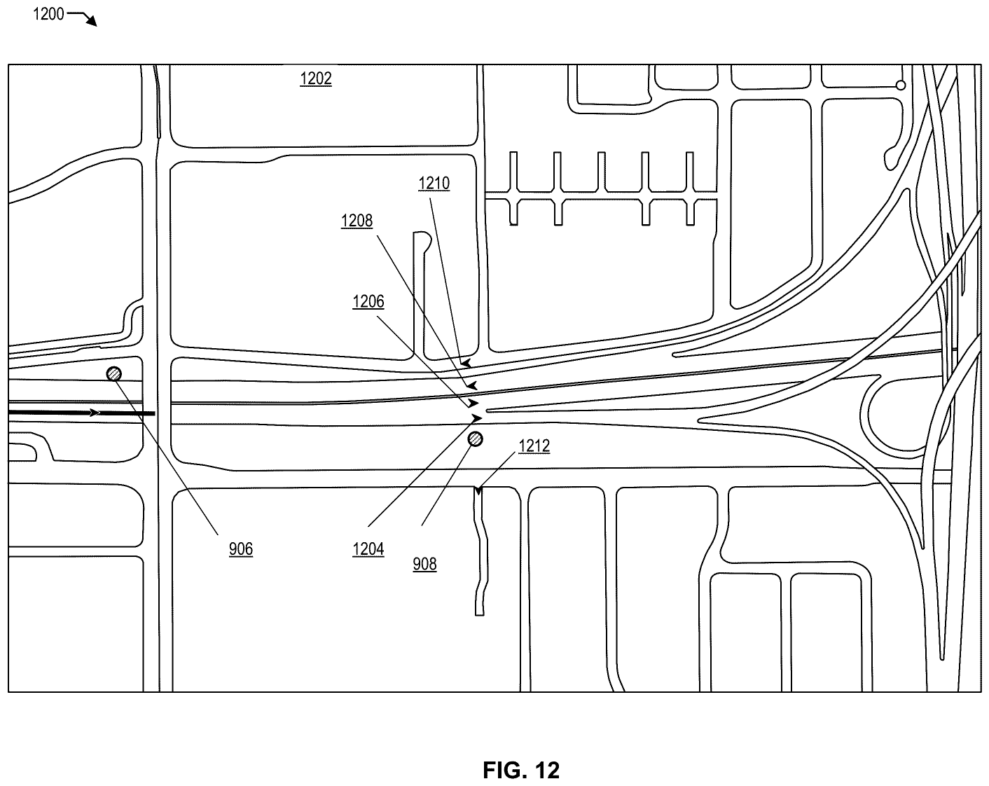

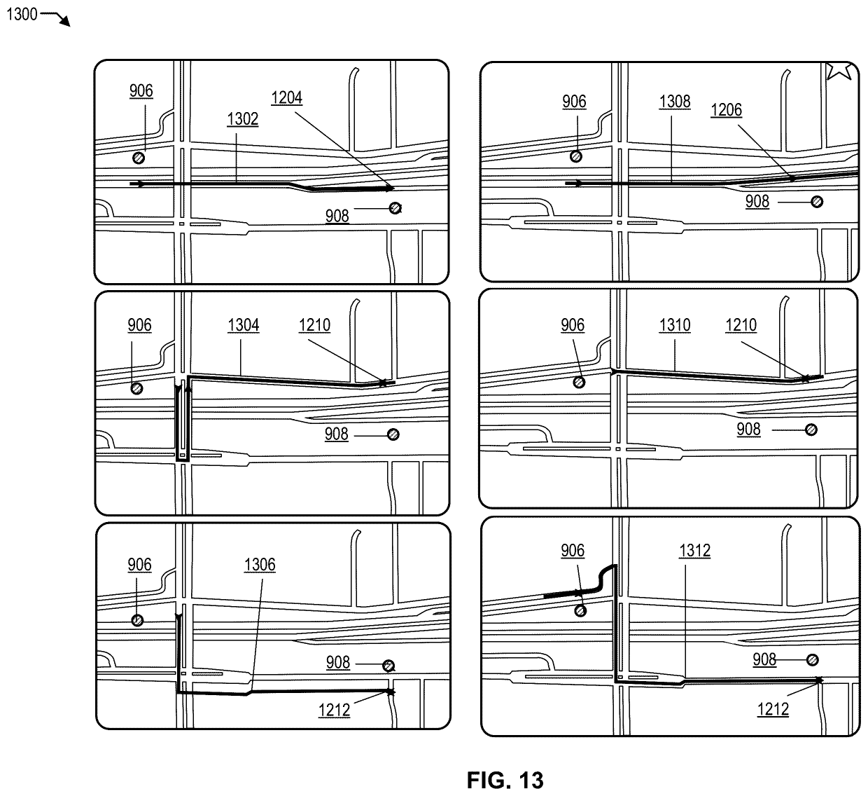

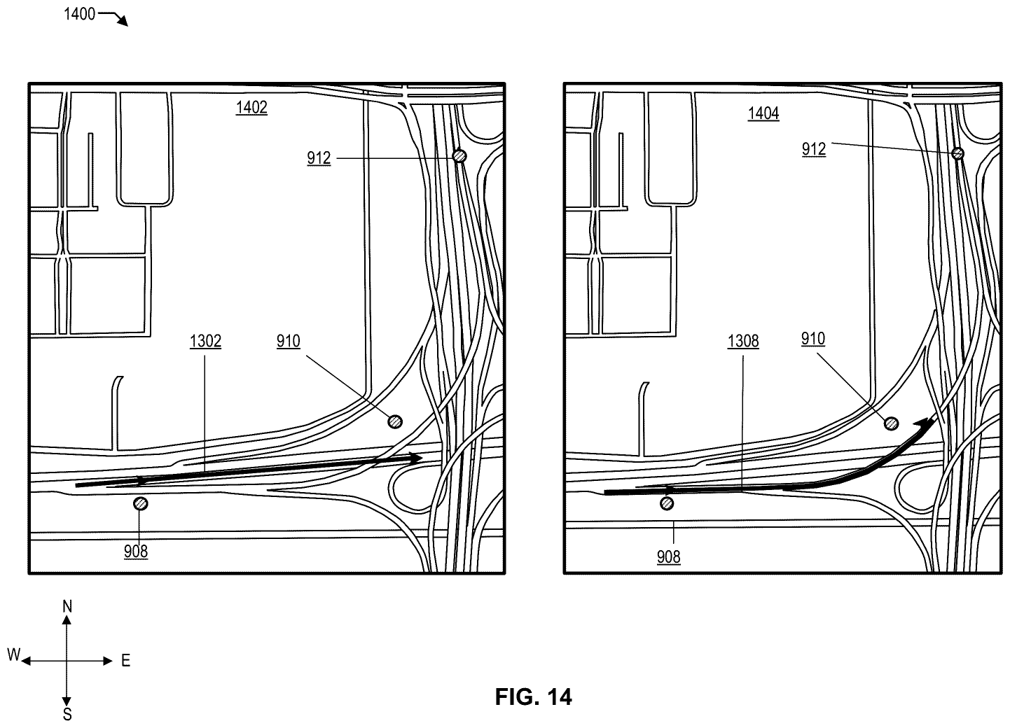

FIGS. 12, 13, 14, and 15 can be viewed together to describe a process for the user device to determine road segments traveled by the user device between the second sparse location data point 906 and the third location data point 908. FIG. 12 is an illustration 1200 of a road network on a map application for route reconstruction, according to one or more embodiments. The road network 1202 illustrated in FIG. 12 is blown up and cropped version of the road network 902 of FIG. 9. The user device can determine that the third sparse location data point 908 can correspond to a tenth candidate road segment 1204, and eleventh candidate road segment 1206, a twelfth candidate road segment 1208, a thirteenth candidate road segment 1210, and a fourteenth candidate road segment 1212. The user device can further filter out candidate road segments using the techniques described above. For example, the user device can use a pathfinding algorithm with a length and time constraint as described above. The length and time constraint can include a determining a maximum length traveled by the user device over a time interval between the second sparse location data point 906 and the third sparse location data point 908 given a reference speed. FIG. 13 is an illustration 1300 of example reconstructed route segments determined by a pathfinding algorithm, according to one or more embodiments. As illustrated FIG. 13 illustrates six different candidate reconstructed route segments that may be determined by the pathfinding algorithm. It should be appreciated that additional candidate reconstructed route segments can be determined by the pathfinding algorithm but have not been illustrated for brevity. FIG. 13 illustrates a first reconstructed route segment 1302, a second reconstructed route segment 1304, a third reconstructed route segment 1306, a fourth reconstructed route segment 1308, a fifth reconstructed route segment 1310, and a sixth reconstructed route segment 1312. Each of the reconstructed route segments can be associated with different starting road segments and ending road segments. The user device can filter out many of the candidate reconstructed route segments based on the previous step. For example, each of the second reconstructed route segment 1304, the third reconstructed route segment 1306, the fifth reconstructed route segment 1310, and sixth reconstructed route segment 1312 do not align with third candidate road segment 1010, and therefore not eligible candidates which can be filtered out by the user device. On the other hand, the first reconstructed route segment 1302 and the fourth reconstructed route segment 1308 are aligned with the third candidate road segment 1010 and therefore are eligible candidates and to be considered by the user device. FIG. 14 assists in describing a process for determining which is the actual route when selecting between the first reconstructed route segment 1302 and the fourth reconstructed route segment 1308.

FIG. 14 is an illustration 1400 of example reconstructed route segments determined by a pathfinding algorithm, according to one or more embodiments. The road networks 1402 and 1404 illustrated in FIG. 14 are blown up and cropped version of the road network 902 of FIG. 9. The first road network 1402 illustrates a continuation of the first reconstructed route segment 1302 and the second road network 1404 illustrates a continuation of the fourth reconstructed route segment 1308. In determining the correct reconstructed route segments between the second sparse location data point 906 and the third sparse location data point 908, the user device can take a holistic approach and consider subsequent location data points. For example, the user device can take into consideration one or both of the fourth sparse location data point 910 and the fifth sparse location data point 912. Referring to the first road network 1402, it is illustrated that a user device traveling along the reconstructed route moves in a generally horizontal direction (e.g., East to West). However, as illustrated, the fourth sparse location data point 910 and a fifth sparse location data point 912 are to the North of the third sparse location data point 908. The user device can determine candidate road segments that correspond to each of the fourth sparse location data point 910, and a fifth sparse location data point 912. The user device can further use a pathfinding algorithm with the constraints described above to determine whether the user device can travel using the first reconstructed route segment 1302 to any of the candidate road segments within the time interval between the third sparse location data point 908 and the fourth sparse location data point 910 as well as within the time interval between third sparse location data point 908 and the fifth sparse location data point 912. The user device can also determine whether the user device can travel using the fourth reconstructed route segment 1308 to any of the candidate road segments within the time interval between the third sparse location data point 908 and the fourth sparse location data point 910 as well as within the time interval between third sparse location data point 908 and the fifth sparse location data point 912.

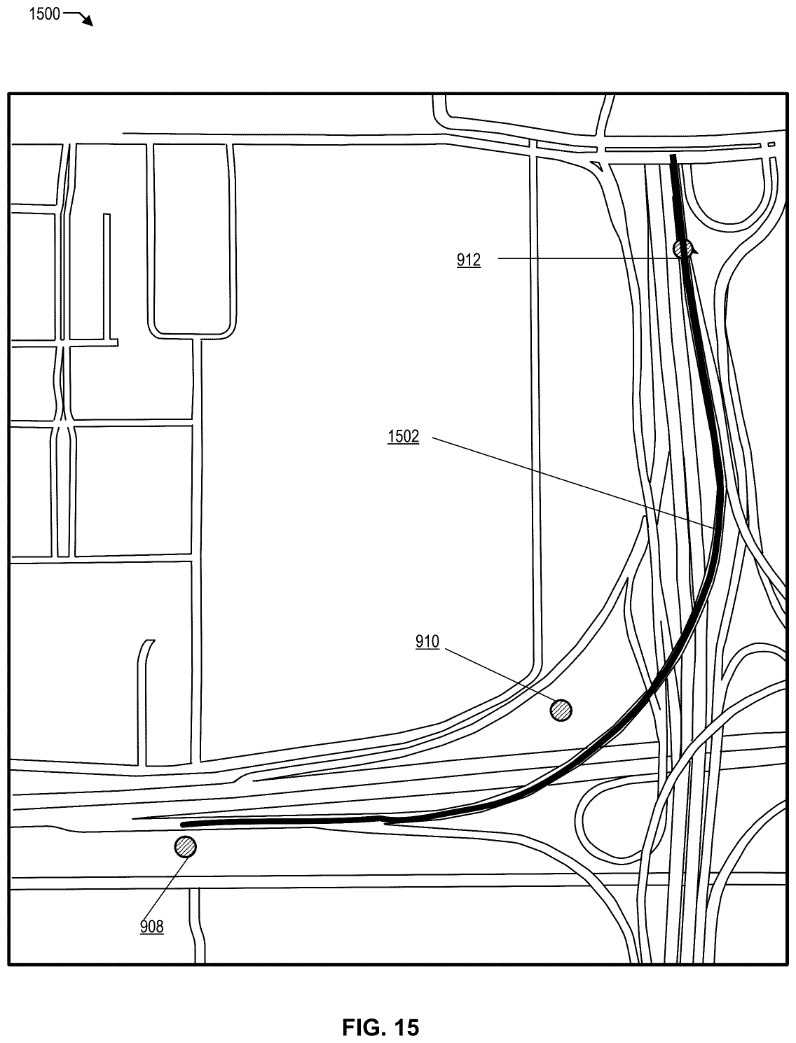

For illustration purposes, the user device can determine that the user device cannot travel using the first reconstructed route segment 1302 to any of the candidate road segments within the time interval between the third sparse location data point 908 and the fourth sparse location data point 910 nor within the time interval between third sparse location data point 908 and the fifth sparse location data point 912. It can also be assumed that the user device can travel using the fourth reconstructed route segment 1308 to any of the candidate road segments within the time interval between the third sparse location data point 908 and the fourth sparse location data point 910 as well as within the time interval between third sparse location data point 908 and the fifth sparse location data point 912. FIG. 15 is an illustration 1500 of a reconstructed route, according to one or more embodiments. As illustrated, the user device has used a pathfinding algorithm to determine a set of reconstructed route segments 1502 that align with candidate road segments corresponding to the third sparse location data point 908, the fourth sparse location data point 910 and the fifth sparse location data point 912.

Referring back to FIG. 14, the user device can use the pathfinding algorithm to determine the fourth reconstructed route segment 1308 based on the above. The user device can repeat this process until it has determined reconstructed route segments that connect with each other and lead from the first location data point 906 to the fifth sparse location data point 912. Referring back to FIG. 7, it was discussed that the user device can use the above-described techniques to correct a reconstructed route segment (e.g., reconstructed route segment 706) to connect with correctly aligned reconstructed route segments (e.g., first reconstructed route segment 704 and third reconstructed route segment 708). It should be appreciated that the method described with respect to FIGS. 8-15 can be used to connect correctly aligned reconstructed route segments or to initially align reconstructed route segments with candidate road segments.

As indicated above, the functionality is described herein with respect to a user device (e.g., user device 104), the some or all of the functionalities can be controlled by an application (e.g., application 106), or a server device. Implementations within the scope of the present disclosure can be partially or entirely realized using a tangible computer-readable storage medium (or multiple tangible computer-readable storage media of one or more types) (e.g., application 106 encoding one or more computer-readable instructions. It should be recognized that computer-executable instructions can be organized in any format, including applications, widgets, processes, software, and/or components.

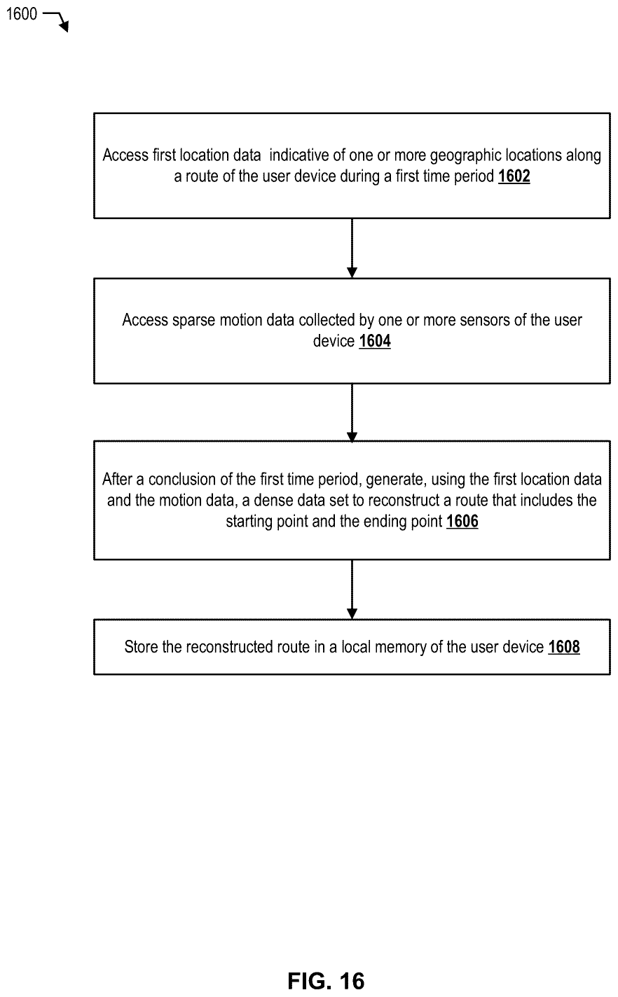

FIG. 16 is a flowchart illustrating a process 1600 for reconstructing a route, according to one or more embodiments. At block 1602, a user device (e.g., the user device 104) can access first location data. The user device can also collect data from wireless connections while along the route) indicative of one or more geographic locations along a route (e.g., route 110) of the user device during a first time period. The route may include a starting location data point (e.g., starting location data point 108) and an ending location data point (e.g., ending location data point 112) of a trip and the user device can collect throughout the route from the starting location data point to the ending location data point.

The user device can be located in a vehicle (e.g., vehicle 102) traveling along the route and access the sparse location data (e.g., sparse location data 118). For example, by communicating with an application on the user device, where the application includes a location service. For example, the user device can use an API, as described below, to communicate with a ride-sharing service application on the user device and access location data.

The user device can detect a trigger to start collecting the sparse location data and the motion data. For example, a service can provide an indication that the user device is moving along a trip. Based on the trigger, the user device can transmit control instructions to one or more sensors to begin collecting location data and the motion data.

At block 1604, the user device can access motion data (e.g., motion data 120) collected by one or more sensors of the user device. The motion data may be collected by the one or more sensors during the first time period. The first time period can correspond to a time period the user device is moving between the starting location data point and the ending location data point of the trip.

The user device can access the sparse location data and the motion data in real time during the first time period. For example, the user device can be located in a traveling vehicle and collect the sparse location data and the motion data while traveling along the route. The user device can further store the sparse location data and the motion data in local memory after the conclusion of the first time period for later use to reconstruct a route.

In some embodiments, the user device can further access road network data (e.g., accessing a map application map tile) based on the one or more geographic locations along the route (e.g., using the location data to determine appropriate road network data from a road network). The road network data may represent a plurality of road segments of a road network. For example, one or more map tiles can be available for use by the computing device. The computing device can compare the collected location data with the location data associated with each map tile. The user device can further select a map tile that includes the highest number of corresponding location data between the collected location data and the location data associated with the map tile.

At 1606, the user device, after a conclusion of the first time period, can generate, using the sparse location data and the motion data, a reconstructed route (e.g., reconstructed route 128), a dense data set to reconstruct a route that includes the starting location data point and the ending location data point, the reconstructed route and including second dense location data and velocity data. The user device can use a dead reckoning technique to reconstruct the route. The user device can generate inferred data using the first location data, motion data. The user device can further generate a motion-based route based on the starting location data point and the motion data. The user device can further update the motion-based route based at least in part on using the location data as a constraint. As indicated above, in some embodiments, the user device can consider the updated motion-based route the reconstructed route. In some other embodiments, the user device can access a map tile and then generate the reconstructed route based at least in part on further updating the updated motion-based route using road network data as a constraint. As indicated above, in some instances, the user device is not able to use the motion data to accurately generate a reconstructed route. Rather one or more gaps in the reconstructed route (e.g., second reconstructed route segment 706) may result from the motion data. Therefore, the user device may use location data to identify candidate road segments and selecting from the candidate road segments to associate a location data point.

It should be appreciated that the route reconstruction can be also performed in real-time. For example, as the user device is traveling in a vehicle, the user device can reconstruct the route. Furthermore, the user device can display the reconstructed route in real-time. For example, as the user device is traveling in the vehicle, the user device can reconstruct the route and generate a graphical representation of the reconstructed that is displayed on the user device. Therefore, the user does not need to wait to the end of a trip to view the reconstructed route.

Furthermore, in addition to the sparse location data and the motion data, the user device can use additional data, including the start time and the stop time for the route, the user's dominant mode of travel, the vehicle's parameters of the vehicle used to travel along the route. In some instances, the user device can generate the reconstructed route based on detecting a trigger that the user device is in charging mode and/or connected to Wi-Fi. In this sense, the user device can prevent the battery life of the user device from being drained.

The user device can engage in various processing steps to generate the reconstructed route. For example, the user device can use the collected data to generate a dense set. For example, the dense data set can include inferred data generated using the sparse location data and the motion data. The user device can then use the dense data set to generate a motion-based route. The user device can then update the motion-based route using the sparse location data as a constraint on the route. The user device can then access map data that includes road network data. The user device can then use the road network data as a constraint on the updated motion-based route to generate the reconstructed route.

It should be appreciated that the user device can include an always-on-processor (AOP) (e.g., AOP 402) that is configured to access the sparse location data and the motion data, and reconstruct the route. For example, the AOP can use the dead reckoning technique to reconstruct the route. The AOP can also use the techniques described with respect FIGS. 8-15.

At 1608, the method can include the computing device storing the reconstructed route in a local memory of the user device.

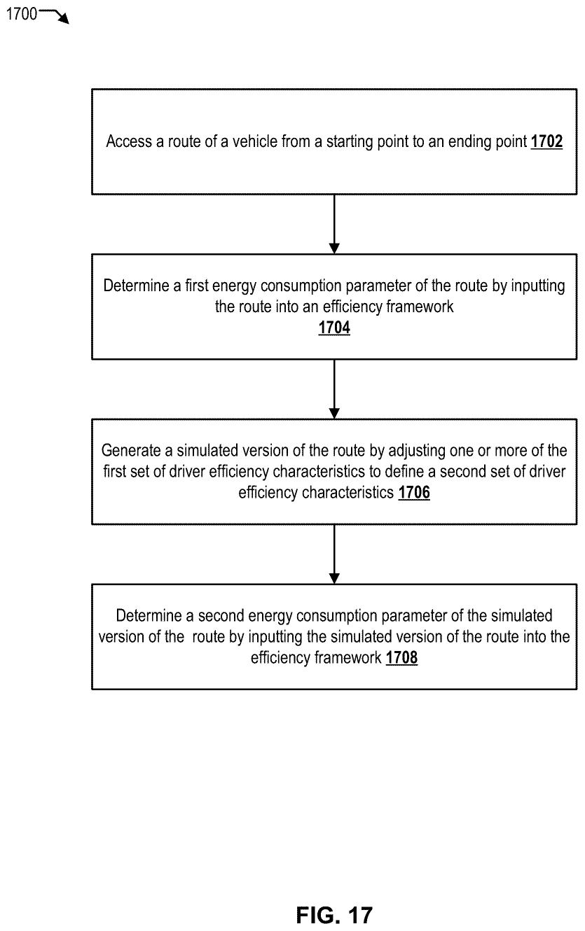

The techniques herein can be used for determination of energy inefficiencies due to driver-controlled vehicle dynamics. For example, the techniques described herein can be use an energy consumption model to assist in determining these energy inefficiencies. FIG. 17 is a process flow 1700 for analyzing a route, according to one or more embodiments. At 1702, a user device (e.g., the user device 104) can access a route of a vehicle (e.g., vehicle 102) from a starting location data point to an ending location data point. The route can be a route that has been reconstructed using sparse location data and the techniques described herein. (e.g., reconstructed route 128). The route can also be reconstructed using other techniques. For example, the route can be reconstructed using a set of dense 1 Hz global navigation satellite system (GNSS) data. In another example the route can be reconstructed using a combination of dense location data and sparse location data. The route can be associated with an actual driver (e.g., the owner of the user device) and representative of a first set of driving efficiency characteristics. The route can be generated as described above.

In some instances, the user device analyzes the route based on detecting a trigger. For example, the user device determines that the user device is in a charging mode. The user device then accesses the route for analysis based on being in the charging mode.

At 1704, the user device can determine a first energy usage parameter (e.g., energy usage while traveling along the route) of the route by inputting the route into an energy consumption model. The energy consumption model can be implemented by an always on processor and include one or more models for receiving driving parameters and outputting a first energy usage parameter. It should be appreciated that the computing device can determine more than one energy usage parameter based on the received data.

At 1706, the user device can generate a simulated version (e.g., a visual representation) of the route by adjusting one or more of the first set of driving efficiency characteristics to define a second set of driving efficiency characteristics (e.g., adjusting at least one driving efficiency characteristic, such as speed or route traveled, to generate a simulated route) associated with a reference driver of the vehicle.

The user device can select the reference driver based on a second energy usage parameter. For example, if the second energy usage parameter is consumption of gasoline, the user device can select a reference driver that has a driving pattern that results in an optimal consumption of gasoline over the route. It should be appreciated that the energy usage parameter is not necessarily the consumption of gasoline, but can be any desirable energy usage parameter that is the result of driving (e.g., drive time, drive distance, gas emission). The simulated version of the route can be based at least in part on the selected reference driver.

At 1708, the user device can determine a second energy usage parameter (the second energy usage parameter can describe the same parameter as the first energy usage parameter, such as energy usage while traveling along route) of the simulated version of the route by inputting the simulated version of the route into the energy consumption model. It should be appreciated that the computing device can determine more than one energy usage parameter based on the received data.

The user device can create multiple simulated version of the route by adjusting the driving efficiency characteristics. Take for example a set of driving efficiency characteristics that includes three driving efficiency characteristics (e.g., average speed, average time for acceleration, and average time for deceleration). The user device can iteratively adjust each driving efficiency characteristic to conform to a reference driver and maintain the remaining other two driving efficiency characteristics as is, to generate three simulated versions of the route. The user device can then iteratively adjust sets of two driving efficiency characteristics to conform to a reference driver and maintain the remaining third driving efficiency characteristics to generate three additional simulated versions of the route. The user device can then adjust all three driver efficiency characteristics to conform to a reference driver to generate one additional simulated version of the route.

The user device can then compare each of the simulated versions of the route to the route to determine the difference in energy usage parameters of the route and each simulated versions of the route. The user device can further determine the influence of each driving efficiency characteristic on energy usage parameters. For example, continuing with the three driving efficiency characteristics (e.g., average speed, average time for acceleration, and average time for deceleration). The user device can compare the first energy usage parameter (e.g., gallons of gasoline consumed) of the route and the second energy usage parameter (e.g., gallons of gasoline consumed) of the simulated versions of the route, in which only the average speed was adjusted to conform to the reference driver to determine a first difference in the energy usage parameters. The user device can also compare the first energy usage parameter (e.g., gallons of gasoline consumed) of the route and the third energy usage parameter (e.g., gallons of gasoline consumed) of the simulated version of the route in which only the average time for acceleration was adjusted to conform to the reference driver to determine a second difference in the energy usage parameters.

The user device can then analyze the first difference and the second difference to determine whether adjusting the speed or adjusting the average time for acceleration had a greater influence on a difference from the energy usage parameter of the reconstructed route. For example, the simulated version of the route with adjusted average speed results in fewer gallons of gasoline consumed than the simulated version of the route with adjected average time for acceleration.

At 1710, the user device can provide for presentation at the user device a comparison of the first energy usage parameter and the second energy usage parameter (e.g., the first and second energy usage parameters and a delta between the first and second energy usage parameters). For example, if the compared energy usage parameter includes an estimated carbon dioxide emission, the computing device can determine the difference in the estimated carbon dioxide emission associated with the route and the estimated carbon dioxide emission associated with the simulated route.

The user device can further generate recommendations based on the compared energy usage parameter. As indicated above, the user device can employ a neural network with a reasoning layer that can generate one or more recommendations for driving improvement. In the instance that the user device generated multiple simulated versions of the route, the user device can generate recommendations based on the comparisons of the energy usage parameters of each simulated versions of the route and the route. For example, if an energy usage parameter is consumption of gasoline the user device can recommended driving at a more consistent speed. If the energy usage parameter is gas emitted from the vehicle, the user device can recommend another route that is shorter than the reconstructed route. The presentation of the comparison of energy usage parameters and the recommendations can be presented on a user interface of the user device.

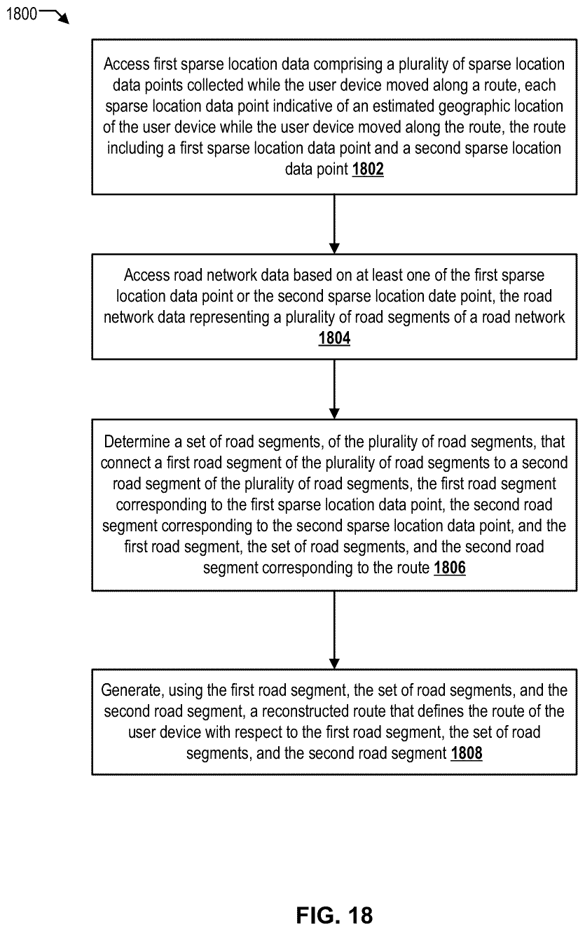

FIG. 18 is a process 1800 for analyzing a reconstructed route, according to one or more embodiments. At 1802, the process 1800 can include a user device (e.g., user device 104) accessing first sparse location data (e.g., a set of first sparse location data of the sparse location data 118) the includes a plurality of sparse location data points collected while the user device moved along a route (e.g., route 110). Each sparse location data point can be indicative of an estimated geographic location of the user device while the user device moved along the route. The route can include a first sparse location data point and a second sparse location data point.

At 1804, the process 1800 can include the user device accessing road network data based on at least one of the first sparse location data point (e.g., first sparse location data point 904) or the second sparse location data point (e.g., second location data point). The road network data can represent a plurality of road segments of a road network (e.g., road network 802, 902, 1002, 1202, and 1402).

At 1806, the process 1800 can include the user device determining a set of road segments of the plurality of road segments, that connect a first road segment of the plurality of road segments to a second road segment of the plurality of road segments. The first road segment can correspond to the first sparse location data point. The second road segment can correspond to the second sparse location data point. The first road segment, the set of road segments, and the second road segment can correspond to the route. For example, as described with respect to FIGS. 10 and 11, the user device can use pathfinding algorithm (e.g., A* search algorithm) to determine a candidate route segments the correspond to sparse location data points. For example, the user device can select a first road segment based on a proximity parameter (e.g., a threshold distance) to the first sparse location data point. The user device can also select the select a second road segment based on the proximity parameter to the second sparse location data point.

In some instances, the user device can place a constraint on the pathfinding algorithm. for example, the user device can use a length-based constraint. The user device can determine a time interval between the first sparse location data point and the second sparse location data point (e.g., t2−t1), The user device can then determine determining a reference velocity of the user device. The reference velocity can be the speed limit on the road. The user device can then determine the set of road segments comprises determining the set of road segments based at least in part on the time interval and the reference velocity. For example, the user device can determine whether, given the reference velocity, could the user device travel a length from a starting road segment to an ending road segment. If the user device could not travel the length within the time interval, then the ending road segment can be filtered out as possibility. If the user device could travel the length within the time interval, then the ending road segment can be included in the set of road segments.

In some instances, the sparse location data points can correspond to closely situated roads segment, for example, road segments that are side by side, but accommodating opposite traffic flow directions. In these instances, the user device can consider the traffic flow directions of each road to determine a correct road segment. For example, the user device can access motion data (e.g., motion data 120) that includes a plurality of motion data points. Each motion data point can indicate a respective direction and a respective speed of the user device. The user device can then determine a direction of the user device along the route based at least in part on the plurality of motion data points. For example, a first motion data point of the plurality of motion data points can correspond to a first road segment, and a second motion data point of the plurality of motion data points can corresponds to a second road segment. Based on the information associated with the motion data points (e.g., time stamps, inertial information), the user device can determine which direction the user device is moving.

The user device can further determine which road segment it is traveling along based on the direction the user device is moving and the traffic flow directions of each road segments, such as intermediate road segments between a starting road segment and an ending road segment. This can be use, when two closely situation road segments have opposite traffic flow directions. For example, the user device can determine a direction of the user device along the route based at least in part on the plurality of motion data points, such as when a first motion data point corresponds to the first road segment with a with traffic flow direction, and a second motion data point corresponds to the second road segment having an opposite traffic flow direction. The user device can match the user device's movement direction with the traffic flow direction to determine the correct road segment.

As indicated above, in some instances, the user device can select a candidate road segment from a plurality of road segments that can correspond to a sparse location data point (e.g. third sparse location data point 908), In some instances, the user device can take a holistic approach, in which it considers a subsequent sparse location data point (e.g., fourth location data point 910 and fifth sparse location data point 912). The user device can determine the candidate road segment based on whether the candidate road segment can be used to reach candidate road segments that are associated with the subsequent candidate sparse location data points. For example, the user device can determine a third road segment of the plurality of road segments associated with the third sparse location data point. The user device can further determine a road segment of the set of road segments as the second road segment based at least in part a connection of the second road segment and the third road segment.

At 1808, the process 1800 can include the user device generating, using the first road segment, the set of road segments, and the second road segment, a reconstructed route that defines the route of the user device with respect to the first road segment, the set of road segments, and the second road segment.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

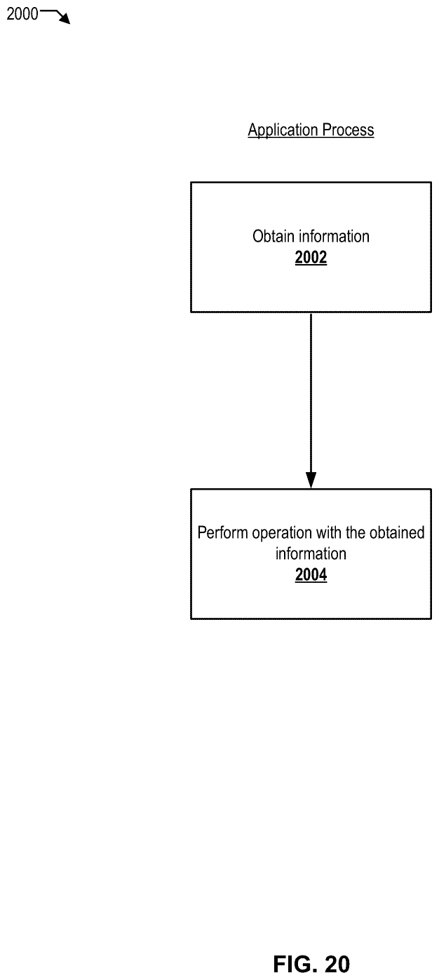

Implementations within the scope of the present disclosure include a computer-readable storage medium that encodes instructions organized as an application (e.g., application 2104) (e.g., application 106) that, when executed by one or more processing units, control an electronic device (e.g., device 2102) (e.g., user device 104) to perform the method of FIG. 19, the method of FIG. 20, and/or one or more other processes and/or methods described herein.

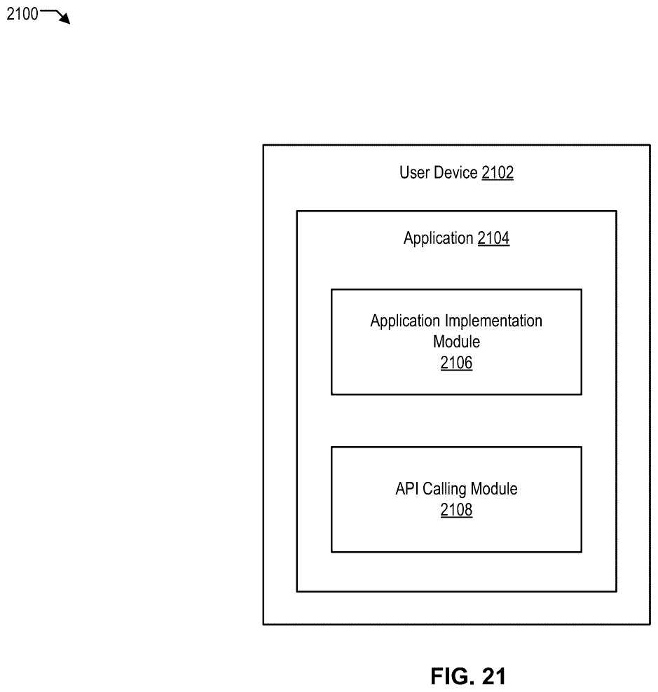

It should be recognized that application 2104 (shown in FIG. 21) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 2104 is an application that is pre-installed on device 2102 at purchase (e.g., a first party application). In other embodiments, application 2104 is an application that is provided to device 2102 via an operating system update file (e.g., a first party application or a second party application). In other embodiments, application 2104 is an application that is provided via an application store. In some embodiments, the application store can be an application store that is pre-installed on device 2102 at purchase (e.g., a first party application store). In other embodiments, the application store is a third-party application store (e.g., an application store that is provided by another application store, downloaded via a network, and/or read from a storage device).

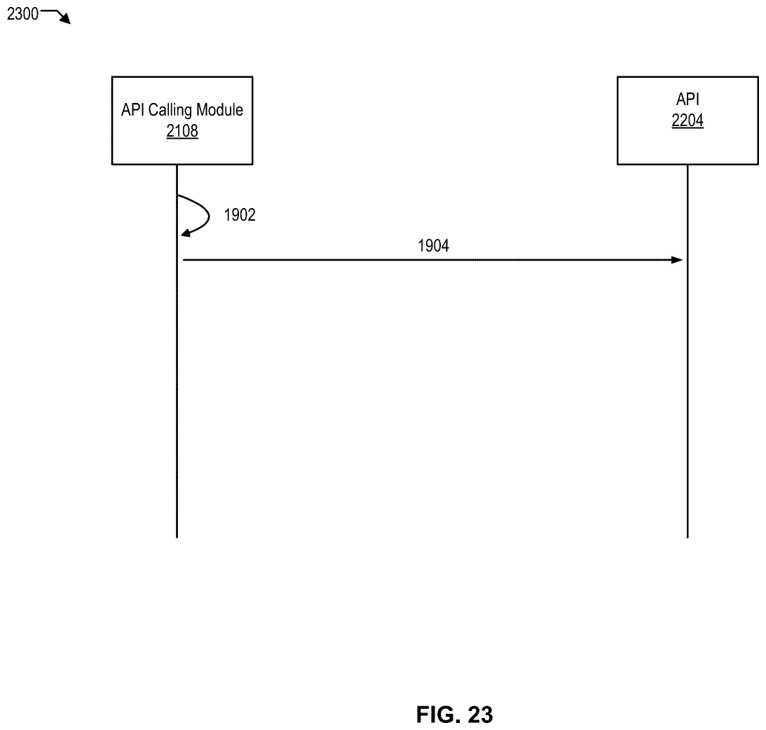

Referring to FIG. 19 and FIG. 23, application 2104 obtains information (e.g., 1902). In some embodiments, at 1902, information is obtained from at least one hardware component of the device 2102. In some embodiments, at 1902, information is obtained from at least one software module of the device 2102. In some embodiments, at 1902, information is obtained from at least one hardware component external to the device 2102 (e.g., a peripheral device, an accessory device, a server, etc.). In some embodiments, the information obtained at 1902 includes sparse location information, motion information, positional information, time information, notification information, user information, environment information, electronic device state information, weather information, media information, historical information, event information, hardware information, and/or motion information. In some embodiments, in response to and/or after obtaining the information at 1902, application 2104 provides the information to a system (e.g., 1904).

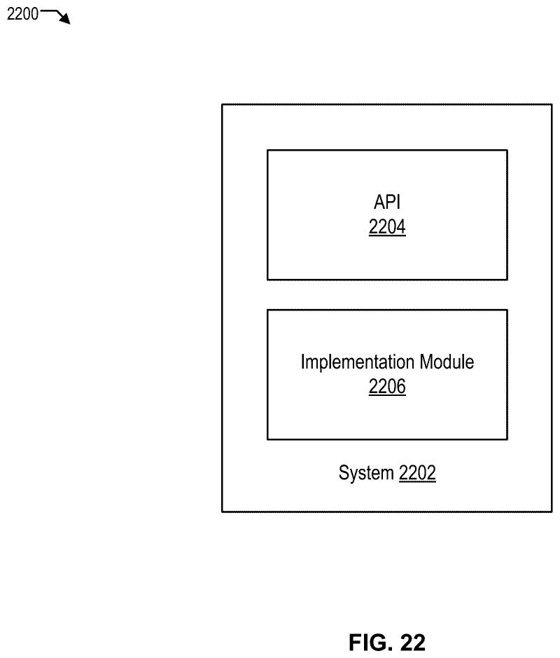

In some embodiments, the system (e.g., 2202 shown in FIG. 22) is an operating system hosted on the device 2102.

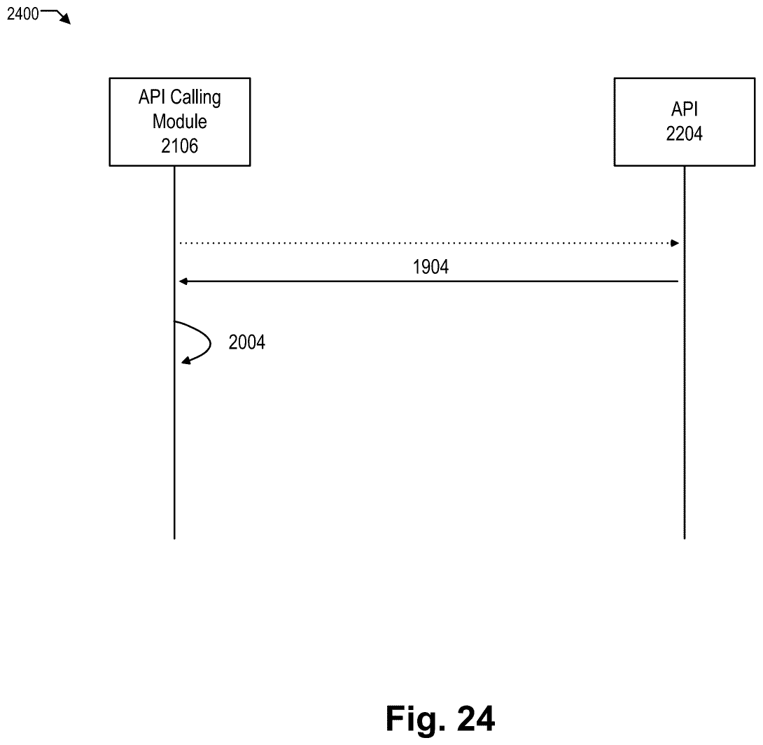

Referring to FIG. 20 and FIG. FIG. 24, application 2104 obtains information (e.g., 2002). In some embodiments, the information obtained at 2002 includes sparse location information, motion information, positional information, time information, notification information, user information, environment information electronic device state information, weather information, media information, historical information, event information, hardware information and/or motion information. In response to and/or after obtaining the information at 2002, application 2104 performs an operation with the information (e.g., 2004). In some embodiments, the operation performed at 2004 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 2202 based on the information.

In some embodiments, one or more steps of the method of FIG. 19 and/or the method of FIG. 20 is performed in response to a trigger. In some embodiments, the trigger includes detection of an event, a notification received from system 2202, a user input, and/or a response to a call to an API provided by system 2202.

In some embodiments, the instructions of application 2104 performs the method of FIG. 19 and/or the method of FIG. 20 by calling an application programming interface (API) (e.g., API 2204) provided by system 2202. In some embodiments, application 2104 performs at least a portion of the method of FIG. 19 and/or the method of FIG. 20 without calling API 2204.

In some embodiments, one or more steps of the method of FIG. 19 and/or the method of FIG. 20 includes calling an API (e.g., API 2204) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 21, device 2102 is illustrated. In some embodiments, device 2102 is a personal computing device, a smart phone, a smart watch, a fitness tracker, a head mounted display (HMD) device, a media device, a communal device, a speaker, a television, and/or a tablet. As illustrated in FIG. 21, device 2102 includes application 2104 and operating system (e.g., system 2202 shown in FIG. 22). Application 2104 includes application implementation module 2106 and API calling module 2108. System 2202 includes API 2204 and implementation module 2206. It should be recognized that device 2102, application 2104, and/or system 2202 can include more, fewer, and/or different components than illustrated in FIGS. 21 and 22.

In some embodiments, application implementation module 2106 includes a set of one or more instructions corresponding to one or more operations performed by application 2104. For example, when application 2104 is a messaging application, application implementation module 2106 can include operations to receive and send messages. In some embodiments, application implementation module 2106 communicates with API calling module to communicate with system 2202 via API 2204 (shown in FIG. 22).

In some embodiments, API 2204 is a software module (e.g., a collection of computer-readable instructions) that provides an interface that allows a different module (e.g., API calling module 2108) to access and/or use one or more functions, methods, procedures, data structures, classes, and/or other services provided by implementation module 2206 of system 2202. For example, API-calling module 2108 can access a feature of implementation module 2206 through one or more API calls or invocations (e.g., embodied by a function or a method call) exposed by API 2204 and can pass data and/or control information using one or more parameters via the API calls or invocations. In some embodiments, API 2204 allows application 2104 to use a service provided by a Software Development Kit (SDK) library. In other embodiments, application 2104 incorporates a call to a function or method provided by the SDK library and provided by API 2204 or uses data types or objects defined in the SDK library and provided by API 2204. In some embodiments, API-calling module 2108 makes an API call via API 2204 to access and use a feature of implementation module 2206 that is specified by API 2204. In such embodiments, implementation module 2206 can return a value via API 2204 to API-calling module 2108 in response to the API call. The value can report to application 2104 the capabilities or state of a hardware component of device 2102, including those related to aspects such as input capabilities and state, output capabilities and state, processing capability, power state, storage capacity and state, and/or communications capability. In some embodiments, API 2204 is implemented in part by firmware, microcode, or other low level logic that executes in part on the hardware component.

In some embodiments, API 2204 allows a developer of API-calling module 2108 (which can be a third-party developer) to leverage a feature provided by implementation module 2206. In such embodiments, there can be one or more API-calling modules (e.g., including API-calling module 2108) that communicate with implementation module 2206. In some embodiments, API 2204 allows multiple API-calling modules written in different programming languages to communicate with implementation module 2206 (e.g., API 2204 can include features for translating calls and returns between implementation module 2206 and API-calling module 2108) while API 2204 is implemented in terms of a specific programming language. In some embodiments, API-calling module 2108 calls APIs from different providers such as a set of APIs from an OS provider, another set of APIs from a plug-in provider, and/or another set of APIs from another provider (e.g., the provider of a software library) or creator of the another set of APIs.

Examples of API 2204 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 2102. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 2206 is a system (e.g., operating system, server system) software module (e.g., a collection of computer-readable instructions) that is constructed to perform an operation in response to receiving an API call via API 2204. In some embodiments, implementation module 2206 is constructed to provide an API response (via API 2204) as a result of processing an API call. By way of example, implementation module 2206 and API-calling module 2108 can each be any one of an operating system, a library, a device driver, an API, an application program, or other module. It should be understood that implementation module 2206 and API-calling module 2108 can be the same or different type of module from each other. In some embodiments, implementation module 2206 is embodied at least in part in firmware, microcode, or other hardware logic.

In some embodiments, implementation module 2206 returns a value through API 2204 in response to an API call from API-calling module 2108. While API 2204 defines the syntax and result of an API call (e.g., how to invoke the API call and what the API call does), API 2204 might not reveal how implementation module 2206 accomplishes the function specified by the API call. Various API calls are transferred via the one or more application programming interfaces between API-calling module 2108 and implementation module 2206. Transferring the API calls can include issuing, initiating, invoking, calling, receiving, returning, and/or responding to the function calls or messages. In other words, transferring can describe actions by either of API-calling module 2108 or implementation module 2206. In some embodiments, a function call or other invocation of API 2204 sends and/or receives one or more parameters through a parameter list or other structure.

In some embodiments, implementation module 2206 provides more than one API, each providing a different view of or with different aspects of functionality implemented by implementation module 2206. For example, one API of implementation module 2206 can provide a first set of functions and can be exposed to third party developers, and another API of implementation module 2206 can be hidden (e.g., not exposed) and provide a subset of the first set of functions and also provide another set of functions, such as testing or debugging functions which are not in the first set of functions. In some embodiments, implementation module 2206 calls one or more other components via an underlying API and thus be both an API calling module and an implementation module. It should be recognized that implementation module 2206 can include additional functions, methods, classes, data structures, and/or other features that are not specified through API 2204 and are not available to API calling module 2108. It should also be recognized that API calling module 2108 can be on the same system as implementation module 2206 or can be located remotely and access implementation module 2206 using API 2204 over a network. In some embodiments, implementation module 2206, API 2204, and/or API-calling module 2108 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

In some embodiments, method 700 (FIG. 7) is performed at a first user device (e.g., user device 104) or a server device via a process (e.g., an operating system process,) that is different from one or more applications executing and/or installed on the first computer system.

In some embodiments, method 700 (FIG. 7) is performed at a first computer system (as described herein) by an application that is different from a system process. In some embodiments, the instructions of the application, when executed, control the first computer system to perform method 700 (FIG. 7) by calling an application programming interface (API) provided by the system process. In some embodiments, the application performs at least a portion of method 700 without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., $50) that runs the application. In some embodiments, the implementation module is included in an electronic device that is separate from the device that runs the application.

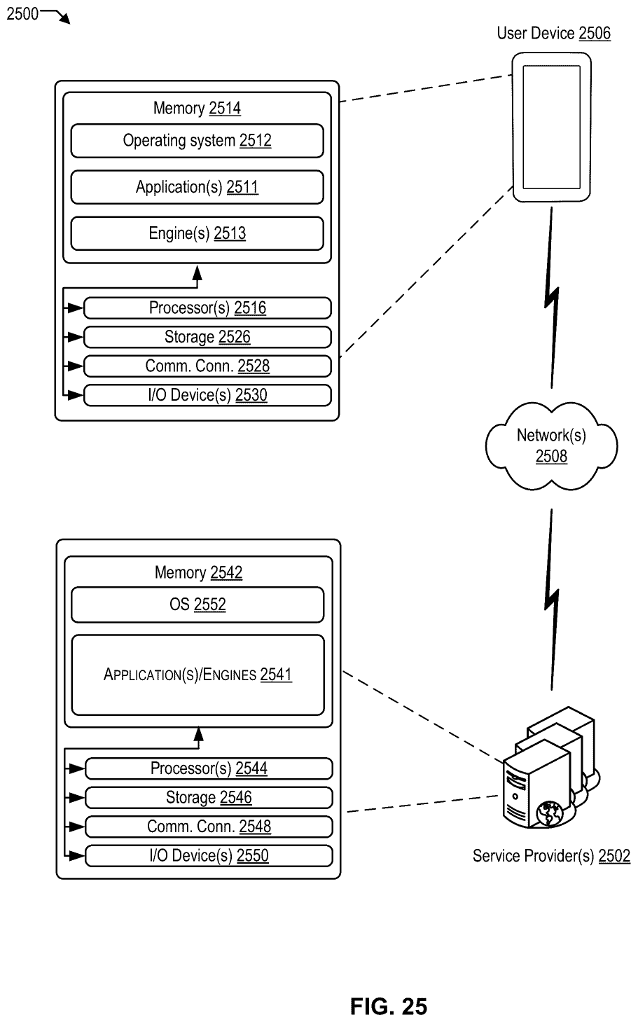

FIG. 25 illustrates an example architecture or environment 2500 configured to implement techniques described herein, according to at least one example. The architecture 2500 includes a user device 2506 (e.g., the user device 104) and a service provider computer 2502 (e.g., a location service, a motion data service). In some examples, the example architecture 2500 may further be configured to enable the user device 2506 and the service provider computer 2502 to share information. In some examples, the devices may be connected via one or more networks 2508 (e.g., via Bluetooth, WiFi, the Internet). In some examples, the service provider computer 2502 may be configured to implement at least some of the techniques described herein with reference to the user device 2506 and vice versa.

In some examples, the networks 2508 may include any one or a combination of many different types of networks, such as cable networks, the Internet, wireless networks, cellular networks, satellite networks, other private and/or public networks, or any combination thereof. While the illustrated example represents the user device 2506 accessing the service provider computer 2502 via the networks 2508, the described techniques may equally apply in instances where the user device 2506 interacts with the service provider computer 2502 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 2506 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 2506 may be in communication with the service provider computer 2502 via the network 2508, or via other network connections.

In one illustrative configuration, the user device 2506 may include at least one memory 2514 and one or more processing units (or processor(s)) 2516. The processor(s) 2516 may be implemented as appropriate in hardware, computer-executable instructions, firmware, or combinations thereof. Computer-executable instructions or firmware implementations of the processor(s) 2516 may include computer-executable or machine-executable instructions written in any suitable programming language to perform the various functions described. The user device 2506 may also include geo-location devices (e.g., a global positioning system (GPS) device or the like) for providing and/or recording geographic location data associated with the user device 2506. In some examples, the processors 2516 may include a GPU and a CPU.

The memory 2514 may store program instructions that are loadable and executable on the processor(s) 2516, as well as data generated during the execution of these programs. Depending on the configuration and type of the user device 2506, the memory 2514 may be volatile (such as random access memory (RAM)) and/or non-volatile (such as read-only memory (ROM), flash memory). The user device 2506 may also include additional removable storage and/or non-removable storage 2526 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 2514 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 2514 and the additional storage 2526, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 2514 and the additional storage 2526 are both examples of non-transitory computer-storage media. Additional types of computer-storage media that may be present in the user device 2506 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 2506. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 2506 may also contain communications connection(s) 2528 that allow the user device 2506 to communicate with a data store, another computing device or server, user terminals, and/or other devices via the network 2508. The user device 2506 may also include I/O device(s) 2530, such as a keyboard, a mouse, a pen, a voice input device, a touch screen input device, a display, speakers, and a printer.

Turning to the contents of the memory 2514 in more detail, the memory 2514 may include an operating system 2512 and/or one or more application programs or services for implementing the features disclosed herein such as applications 2511 and engine 2513 (e.g., an engine for reconstructing a route, an engine for determining an energy efficiency, and any other engine for performing the techniques described herein). At least some techniques described with reference to the service provider computer 2502 may be performed by the user device 2506 and vice versa.

The service provider computer 2502 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 2502 may be in communication with the user device 2506 via the network 2508, or via other network connections.

In one illustrative configuration, the service provider computer 2502 may include at least one memory 2542 and one or more processing units (or processor(s)) 2544. The processor(s) 2544 may be implemented as appropriate in hardware, computer-executable instructions, firmware, or combinations thereof. Computer-executable instructions or firmware implementations of the processor(s) 2544 may include computer-executable or machine-executable instructions written in any suitable programming language to perform the various functions described.

The memory 2542 may store program instructions that are loadable and executable on the processor(s) 2544, as well as data generated during the execution of these programs. Depending on the configuration and type of service provider computer 2502, the memory 2542 may be volatile (such as RAM) and/or non-volatile (such as ROM and flash memory). The service provider computer 2502 may also include additional removable storage and/or non-removable storage 2546 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 2542 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 2542 and the additional storage 2546, both removable and non-removable, are both additional examples of non-transitory computer-readable storage media.

The service provider computer 2502 may also contain communications connection(s) 2548 that allow the service provider computer 2502 to communicate with a data store, another computing device or server, user terminals, and/or other devices via the network 2508. The service provider computer 2502 may also include I/O device(s) 2550, such as a keyboard, a mouse, a pen, a voice input device, a touch input device, a display, speakers, and a printer.

Turning to the contents of the memory 2542 in more detail, the memory 2542 may include an operating system 2552 and/or one or more application programs 2541 or services for implementing the features disclosed herein. The one or more application programs 2541 may be configured to perform similar functions to the applications 2511 and engines 2513. While specific embodiments have been described, one skilled in the art will recognize that numerous modifications are possible. A single controller may use processes described herein to establish pairings with any number of accessories and to selectively communicate with different accessories at different times. Similarly, a single accessory may be controlled by multiple controllers with which it has established pairings. Any function of an accessory may be controlled by modeling the function as a service having one or more characteristics and allowing a controller to interact with (e.g., read, modify, receive updates) the service and/or its characteristics. Accordingly, protocols and communication processes as described herein may be “universal,” meaning that they may be applied in any context with one or more controllers and one or more accessories regardless of accessory function or controller form factor or specific interfaces.

### Examples

In the following sections, further example embodiments are provided.

Example 1 can include a method performed by a user device, the method comprising: accessing sparse location data indicative of one or more geographic locations along a route of the user device during a first time period, the route including a starting location data point and an ending location data point; accessing motion data collected by one or more sensors of the user device, the motion data collected by the one or more sensors during the first time period; after a conclusion of the first time period, generating, using the sparse location data and the motion data, a dense data set to reconstruct a route that includes the starting location data point and the ending location data point, the reconstructed route including second dense location data and velocity data; and storing the reconstructed route in a local memory of the user device.

Example 2 can include the method of example 1, wherein the method further comprises: accessing road network data based on one or more geographic locations along the route, the road network data representing a plurality of road segments of a road network, wherein generating, using the sparse location data and the motion data, a dense data set to reconstruct a route further comprises using the road network data to reconstruct the route.

Example 3 can include the method of example 1 or 2, wherein accessing the sparse location data comprises: accessing the sparse location data from an application operating on the user device.

Example 4 can include the method of any of examples 1-3, wherein the method further comprises: storing the sparse location data in the local memory of the user device during the first time period, wherein the sparse location data is accessed from the local memory of the user device.

Example 5 can include the method of any of examples 1-4, wherein the method further comprises: transmitting control instructions to the one or more sensors to collect the motion data during the first time period.

Example 6 can include the method of any of examples 1-5, wherein the method further comprises: storing the motion data in the local memory of the user device during the first time period, wherein the motion data is accessed from the local memory of the user device.

Example 7 can include the method of any of examples 1-6, wherein generating, using the first sparse location data and the motion data, the dense data set to reconstruct the route comprises: generating inferred data based at least in part on the first sparse location data and the motion data, wherein the dense data set comprises the inferred data, the first sparse location data the motion data, and the second dense location data; and using a dead reckoning technique to reconstruct the route based at least in part on the dense data set.

Example 8 can include the method of example 7, wherein using the dead reckoning technique comprises: generating a candidate route based on the starting point and the motion data; and updating the candidate route to traverse an intermediate point of the first sparse location data.

Example 9 can include the method of any of examples 1-8, wherein the method further comprises: detecting that the user device is in a charging mode; and generating, using the first sparse location data and the motion data, the dense data set to reconstruct the route based at least in part on the detection.

Example 10 can include the method of any of examples 1-9, wherein the method further comprises: detecting that the user device is connected to a Wi-Fi network; and generating, using the first sparse location data and the motion data, the dense data set to reconstruction the route based at least in part on the detection.

Example 11 can include the method of any of examples 1-10, wherein generating, using the first sparse location data and the motion data, the dense data set to reconstruct the route comprises: using an always-on-processor (AOP) to generate inferred data based at least in part on the first sparse location data and the motion data, wherein the dense data set comprises the inferred data, the first sparse location data, the second dense location data, and the motion data, and wherein the AOP uses a dead reckoning technique to reconstruct the route based at least in part on the dense data set.

Example 12 can include the method of any of examples 1-11, wherein the method further comprises: detecting a trigger to activate the one or more sensors to collect the motion data; and transmitting control instructions to the one or more sensors to collect the motion data based at least in part on detecting the trigger.

Example 13 can include the method of any of examples 1-12, wherein the method further comprises: accessing a start time and a stop time of the route, a user's dominant mode of travel, and vehicle parameters, wherein generating, using the first sparse location data and the motion data, a dense data set to reconstruct a route further comprises using the start time and the stop time of the route, the user's dominant mode of travel, and the vehicle parameters.

Example 14 can include the method of any of examples 1-13, wherein the method further comprises: detecting a trigger to reconstruct the route; and reconstructing the route based at least in part on detecting the trigger.

Example 15 can include any of the examples 1-14, wherein the user device is arranged in a vehicle that is traveling the route.

Example 16 can include the method of any of examples 1-15, wherein the method further comprises: accessing road network data based on the sparse location data, the road network data representing a plurality of road segments of a road network; determining a first road segment that connects to a second road segment, the first road segment corresponding to a first sparse location data point of the sparse location data, the second road segment corresponding to a second sparse location data point of the sparse location data, and the first road segment and the second road segment corresponding to the route; and generating, using the first road segment and the second road segment, a reconstructed route that defines the route of the user device with respect to the first road segment and the second road segment.

Example 17 can include the method of any of examples 1-16, wherein determining the first road segment comprises evaluating the first sparse location data point with respect to a first proximity parameter, and wherein determining the second road segment comprises evaluating the second sparse location data point with respect to a second proximity parameter.

Example 18 can include a computing device including memory having instructions and processing circuitry coupled with the memory to execute the instructions to perform any of the steps of examples 1-17.

Example 19 can include one or more non-transitory, computer-readable media, wherein the instructions, when executed, further cause an apparatus to perform any of the steps of examples 1-17.

Example 20 can include a method performed by a user device, the method comprising: accessing a route of a vehicle from a starting point to an ending point, the route associated with an actual driver and representative of a first set of driving efficiency characteristics; determining a first energy usage parameter of the route by inputting the route into an energy consumption model; generating a simulated version of the route by adjusting one or more of the first set of driving efficiency characteristics to define a second set of driving efficiency characteristics, the simulated version of the route associated with a reference driver of the vehicle; determining a second energy usage parameter of the simulated version of the route by inputting the simulated version of the route into the energy consumption model; and providing for presentation at the user device a comparison of the first energy usage parameter and the second energy usage parameter.

Example 21 can include the method of example 20, wherein the method further comprises: selecting a driving pattern of the reference driver based at least in part on the second energy usage parameter; and generating the simulated version of the route by adjusting one or more driving efficiency characteristic of the first set of driving efficiency characteristics to define a second set of driving efficiency characteristics based at least in part on the driving pattern.

Example 22 can include the method of example 21 or 22, wherein the method further comprises: generating a plurality of simulated versions of the route, wherein each simulated version of the plurality of simulated versions of the route is generated by adjusting a respective driving efficiency characteristic of the first set of driving efficiency characteristics.

Example 23 can include the method of example 22, wherein the method further comprises: selecting a respective reference driver for each simulated version of the route of the plurality of simulated versions of the route, wherein each simulated version of the plurality of simulated versions of the route is further generated based at least in part on the respective reference driver.

Example 24 can include the method of example 23, wherein the method further comprises: determining a respective energy usage parameter of each simulated version of the route of the plurality of simulated versions of the route; comparing the respective energy usage parameter of each simulated version of the route of the plurality of simulated versions of the route with the first energy usage parameter of each simulated version of the route of the plurality of simulated versions of the route; and determining a respective difference between the respective energy usage parameter of each simulated version of the route of the plurality of simulated versions of the route with the first energy usage parameter of each simulated version of the route of the plurality of simulated versions of the route.

Example 25 can include the method of example 23, wherein the method further comprises: determining a respective recommendation based on each respective difference between the respective energy usage parameter of each simulated version of the route of the plurality of simulated versions of the route with the first energy usage parameter of each simulated version of the route of the plurality of simulated versions of the route.

Example 26 can include the method of any of examples 20-25, wherein the method further comprises: determining that the user device is in a charging mode; and accessing the route of a vehicle from the starting point to the ending point based at least in part on determining that the user device is in the charging mode.

Example 27 can include the method of any of examples 20-26, wherein the method further comprises: displaying the comparison of the first energy usage parameter and the second energy usage parameter on a user interface of the user device.

Example 28 can include a computing device including memory having instructions and processing circuitry coupled with the memory to execute the instructions to perform any of the steps of examples 20-27.

Example 29 can include one or more non-transitory, computer-readable media, wherein the instructions, when executed, further cause an apparatus to perform any of the steps of examples 10-27.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Thus, although specific embodiments have been described, it will be appreciated that embodiments may include all modifications and equivalents within the scope of the following claims.

As described above, one aspect of the present technology is the gathering and use of data available from specific and legitimate sources to generate recommendation(s) for improving driver efficiency. The present disclosure contemplates that in some instances, this gathered data may include personal information data that uniquely identifies or may be used to identify a specific person. Such personal information data may include demographic data, location-based data, online identifiers, telephone numbers, email addresses, home addresses, (e.g., retrieving location information from a user specific fitness-based application or a user specific healthcare application for route reconstruction).

The present disclosure recognizes that the use of such personal information data, in the present technology, may be used to the benefit of users. For example, the personal information data may be used to deliver a command from a user profile on a computing device to one or more computing devices. Further, other uses for personal information data that benefit the user are also contemplated by the present disclosure. For instance, recommendations for improving the user's driving efficiency may be transmitted from a device back to the user profile.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities may subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements may be provided to prevent or block access to such personal information data. For example, the present technology may be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

For purposes of explanation, specific configurations and details are set forth in order to provide a thorough understanding of the examples. However, it should also be apparent to one skilled in the art that the examples may be practiced without the specific details. Furthermore, well-known features were sometimes omitted or simplified in order not to obscure the example being described.

User devices can include any of a number of general purpose personal computers, such as laptop computers running a standard operating system, as well as cellular, wireless and handheld devices.

In embodiments utilizing a network server, the network server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more applications that may be implemented as one or more scripts or programs written in any programming language, such as Java®, C, C# or C++, or any scripting language, such as Perl, Python or TCL, as well as combinations thereof. The server(s) may also include database servers, including without limitation those commercially available from Oracle®, Microsoft®, Sybase®, and IBM®

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable storage media for containing code, or portions of code, can include any appropriate media known or used in the art such as, but not limited to, volatile and non-volatile, removable and non-removable media implemented in any method or technology for storage of information such as computer-readable instructions, data structures, program modules or other data, including RAM, ROM, Electrically Erasable Programmable Read-Only Memory (EEPROM), flash memory or other memory technology, CD-ROM, DVD or other optical storage, magnetic cassettes, magnetic tape, magnetic disk storage or other magnetic storage devices or any other medium that can be used to store the desired information and that can be accessed by the a system device. Based at least in part on the disclosure and teachings provided herein, a person of ordinary skill in the art will appreciate other ways and/or methods to implement the various embodiments. However, computer-readable storage media does not include transitory media such as carrier waves or the like.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a,” “an,” and “the,” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based at least in part on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations

1. A method performed by a user device, the method comprising:
accessing sparse location data indicative of one or more geographic locations along a route of the user device during a first time period, the route including a starting location data point and an ending location data point;
accessing motion data collected by one or more sensors of the user device, the motion data collected by the one or more sensors during the first time period;
after a conclusion of the first time period, generating, using the sparse location data and the motion data, a dense data set to reconstruct a route that includes the starting location data point and the ending location data point, the reconstructed route including second dense location data and velocity data; and
storing the reconstructed route in a local memory of the user device.

2. The method of claim 1, wherein the method further comprises:
accessing road network data based on one or more geographic locations along the route, the road network data representing a plurality of road segments of a road network, wherein generating, using the sparse location data and the motion data, a dense data set to reconstruct a route further comprises using the road network data to reconstruct the route.

3. The method of claim 1, wherein accessing the sparse location data comprises:
accessing the sparse location data from an application operating on the user device.

4. The method of claim 1, wherein the method further comprises:
storing the sparse location data in the local memory of the user device during the first time period, wherein the sparse location data is accessed from the local memory of the user device.

5. The method of claim 1, wherein the method further comprises:
transmitting control instructions to the one or more sensors to collect the motion data during the first time period.

6. The method of claim 1, wherein the method further comprises:
accessing road network data based on the sparse location data, the road network data representing a plurality of road segments of a road network;
determining a first road segment that connects to a second road segment, the first road segment corresponding to a first sparse location data point of the sparse location data, the second road segment corresponding to a second sparse location data point of the sparse location data, and the first road segment and the second road segment corresponding to the route; and
generating, using the first road segment and the second road segment, a reconstructed route that defines the route of the user device with respect to the first road segment and the second road segment.

7. The method of claim 6, wherein determining the first road segment comprises evaluating the first sparse location data point with respect to a first proximity parameter, and wherein determining the second road segment comprises evaluating the second sparse location data point with respect to a second proximity parameter.

8. A user device, comprising:
one or more processors; and
one or more memories storing computer-executable instructions that, when executed by the one or more processors, cause the one or more processors to:
access sparse location data indicative of one or more geographic locations along a route of the user device during a first time period, the route including a starting location data point and an ending location data point;
access motion data collected by one or more sensors of the user device, the motion data collected by the one or more sensors during the first time period;
after a conclusion of the first time period, generate, using the sparse location data and the motion data, a dense data set to reconstruct a route that includes the starting location data point and the ending location data point, the reconstructed route including second dense location data and velocity data; and
store the reconstructed route in a local memory of the user device.

9. The user device of claim 8, wherein the instructions that, when executed by the one or more processors, cause the one or more processors to:
access road network data based on one or more geographic locations along the route, the road network data representing a plurality of road segments of a road network, wherein generating, using the sparse location data and the motion data, a dense data set to reconstruct a route further comprises using the road network data to reconstruct the route.

10. The user device of claim 8, wherein accessing the sparse location data comprises:
accessing the sparse location data from an application operating on the user device.

11. The user device of claim 8, wherein the instructions that, when executed by the one or more processors, cause the one or more processors to:
store the sparse location data in the local memory of the user device during the first time period, wherein the sparse location data is accessed from the local memory of the user device.

12. The user device of claim 8, wherein the instructions that, when executed by the one or more processors, cause the one or more processors to:
transmit control instructions to the one or more sensors to collect the motion data during the first time period.

13. The user device of claim 8, wherein the instructions that, when executed by the one or more processors, cause the one or more processors to:
accessing road network data based on the sparse location data, the road network data representing a plurality of road segments of a road network;
determining a first road segment that connects to a second road segment, the first road segment corresponding to a first sparse location data point of the sparse location data, the second road segment corresponding to a second sparse location data point of the sparse location data, and the first road segment and the second road segment corresponding to the route; and
generating, using the first road segment and the second road segment, a reconstructed route that defines the route of the user device with respect to the first road segment and the second road segment.

14. The user device of claim 13, wherein determining the first road segment comprises evaluating the first sparse location data point with respect to a first proximity parameter, and wherein determining the second road segment comprises evaluating the second sparse location data point with respect to a second proximity parameter.

15. One or more non-transitory computer-readable media storing computer-executable instructions that, when executed with one or more processors of a user device, causes the one or more processors to:
access sparse location data indicative of one or more geographic locations along a route of the user device during a first time period, the route including a starting location data point and an ending location data point;
access motion data collected by one or more sensors of the user device, the motion data collected by the one or more sensors during the first time period;
after a conclusion of the first time period, generate, using the sparse location data and the motion data, a dense data set to reconstruct a route that includes the starting location data point and the ending location data point, the reconstructed route including second dense location data and velocity data; and
store the reconstructed route in a local memory of the user device.

16. The one or more non-transitory computer-readable media of claim 15, wherein the instructions that, when executed by the one or more processors, cause the one or more processors to:
access road network data based on one or more geographic locations along the route, the road network data representing a plurality of road segments of a road network, wherein generating, using the sparse location data and the motion data, a dense data set to reconstruct a route further comprises using the road network data to reconstruct the route.

17. The one or more non-transitory computer-readable media of claim 15, wherein accessing the sparse location data comprises:
accessing the sparse location data from an application operating on the user device.

18. The one or more non-transitory computer-readable media of claim 15, wherein the instructions that, when executed by the one or more processors, cause the one or more processors to:
store the sparse location data in the local memory of the user device during the first time period, wherein the sparse location data is accessed from the local memory of the user device.

19. The one or more non-transitory computer-readable media of claim 15, wherein the instructions that, when executed by the one or more processors, cause the one or more processors to:
transmit control instructions to the one or more sensors to collect the motion data during the first time period.

20. The one or more non-transitory computer-readable media of claim 15, wherein the instructions that, when executed by the one or more processors, cause the one or more processors to:
accessing road network data based on the sparse location data, the road network data representing a plurality of road segments of a road network;
determining a first road segment that connects to a second road segment, the first road segment corresponding to a first sparse location data point of the sparse location data, the second road segment corresponding to a second sparse location data point of the sparse location data, and the first road segment and the second road segment corresponding to the route; and
generating, using the first road segment and the second road segment, a reconstructed route that defines the route of the user device with respect to the first road segment and the second road segment.

21. (canceled)

22. (canceled)

23. (canceled)

24. (canceled)

25. (canceled)

26. (canceled)

27. (canceled)

28. (canceled)
